(19) United States
(12) Patent Application Publication
(10) Pub. No.: US 2009/0239001 A1
(43) Pub. Date: Sep. 24, 2009

(54) OPTICAL FILM AND METHOD FOR PRODUCTION THEREOF

(75) Inventor: Katsuhiko Heki, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA OPTO, INC., Tokyo (JP)

(21) Appl. No.: 12/373,203

(22) PCT Filed: Jun. 8, 2007
(86) PCT No.: PCT/JP2007/061619

§ 371 Date: Jan. 9, 2009

(30) Foreign Application Priority Data
Jul. 19, 2006 (JP) 2006-196692

(51) Int. Cl. C09K 19/38; B29D 7/01

(52) U.S. Cl. 428/1.1; 264/1.34

(57) ABSTRACT

Disclosed is a method for producing an optical film having a satisfactory roll-cleaning effect at low cost. Also disclosed is an optical film which can be produced by the method and is less likely to be stained. The method comprises the steps of: pressing a film between a first revolution body and a second revolution body, conveying the film with a third revolution body, and stretching the film, wherein the film is a film-like cellulose resin, the temperature of the cellulose resin during being pressed between the first and second revolution bookies is higher than the melting temperature of an additive, and the line pressure to be employed for the pressing between the first and second revolution bodies is 0.1 to 100 N/mm.

### TECHNICAL FIELD

The present invention relates to an optical film and method for production thereof.

### BACKGROUND ART

The present invention relates to an optical film with excellent flatness fabricated by a melt-casting film forming method and a method for production thereof, wherein the optical film particularly includes optical films which can be used as those various kinds of functional films such as those films in the liquid crystal display apparatus and others: a protective film for a polarizing plate, a phase difference film, and a viewing angle widening film, and such as an antireflection film used in a plasma display, and the optical film also includes various kinds of functional films used in the organic electroluminescence display.

Since the liquid crystal display apparatus is more space saving and energy saving than the conventional CRT display apparatus, it is widely used as a monitor. Such a liquid crystal display apparatus employs various types of optical films including a polarizing film and phase difference film. Incidentally, in the polarizing film as a polarizing plate used in the liquid crystal display apparatus, a cellulose ester film is laminated as a protective film on one side or both sides of the polarizer made up of a stretched polyvinyl alcohol film. The phase difference film is used to enlarge the viewing angle and to improve the contrast. In this case, the film made of polycarbonate, cyclic polyolefin resin or cellulose ester is stretched to provide retardation. This is called the optical correction film.

These optical films are required to have no optical defect, uniform retardation, and in particular no variation in the phase axis. These required qualities are getting higher, particularly due to increase in size and definitions of monitors and TVs.

The optical film manufacturing method can be broadly classified into the melt-casting film forming method and solution-casting film forming method. In the former method, a film is formed by the following steps: heating polymer to melt it, flow-casting the polymer on a support member, and cooling to solidity it, and if needed, stretching the solidified polymer. In the latter method, a polymer is formed by the following steps: dissolving polymer in a solvent, flow-casting it on a support member, and evaporating the solvent, and if needed stretching the dried polymer.

In either method, the molten polymer or polymer solution is solidified by cooling or drying on the support member. After having been separated from the support member, the polymer film is subjected to the process of drying or stretching while being conveyed by a plurality of conveyance rolls.

One of the problems with the solution-casting film forming method is that it has a high environmental load due to use of a large amount of solvent. The melt-casting film forming method is expected to improve productivity since it does not use solvent. The melt-casting film forming method is preferably used for this reason. However, this method has a disadvantage that a resin or additive agent sticks to conveyance rolls at the time of film formation thereby contaminating the conveyance rolls, and if the contamination gets worse, the contamination is transferred onto the film to make spot irregularity or unevenness on the film, with the result that the film is deteriorated. Further, when the rolls are contaminated, production must be interrupted for cleaning the rolls. Therefore, development of a roll cleaning method has been a crucial object to realize continuous production. The aforementioned problems have been noticeable especially for the material containing many additives other than resins.

A roll cleaning method is proposed in the Patent Document 1.

The Patent Document 1 describes a method of cleaning a cooling roll used for removing a low-molecular component stuck on the cooling roll in a laminating apparatus, which is a method and an apparatus for manufacturing resin-coated (laminated) paper, in particular, a laminating apparatus including a step of coating molten resin. According to this cleaning method, the high-output laser light source or the flame of a flame burner is used to apply energy onto the surface of the cooling roll.

The Patent Document 2 describes the method of applying an ultraviolet light onto the surface of the roll used to manufacture films, whereby the deposits are removed from the surface of the roll.

The Patent Document 2 describes the method of removing an organic substance from the rotating member by applying plasma to the rotating member in contact with a traveling film for the purpose of reducing the damage on the surface of the film that occurs during the step of forming a thermoplastic film and of removing the contamination from a rotating member.

Patent Document 1: Japanese Unexamined Patent Application Publication No. 2002-240125

Patent Document 2: Japanese Unexamined Patent Application Publication No. 2003-89142

Patent Document 3: Japanese Unexamined Patent Application Publication No. 2001-62911

### DISCLOSURE OF THE INVENTION

### Object of the Invention

The techniques disclosed in the Patent Documents 1 through 3, however, have a problem that the costs of both the equipment and operation are high.

An object of the present invention is to solve the aforementioned problems and to provide a method of producing an optical film at a reduced cost wherein rolls are effectively prevented from being contaminated, and an optical film manufactured by this production method wherein this film is characterized by reduced contamination.

### Means for Solving the Object

The object of the present invention can be achieved by the following means:

1. A method for manufacturing an optical film, the method comprising, in the following order, the steps of:

melting a cellulose resin into a molten cellulose resin, the cellulose resin including additive agent;

extruding the molten cellulose resin from a melts casting die in a film-like form by using an extruder; and

forming a film by pinching the extruded film-like cellulose resin between a first rotating member and a second rotating member,

wherein temperature of the film-like cellulose resin pinched between the first rotating member and the second rotating member is equal to or higher than a melting point of the additive agent, and a line pressure between the first rotating member and the second rotating member when the film-like cellulose resin is pinched is from 0.1 to 100 N/mm.

2. The method of manufacturing an optical film of 1, comprising, after the step of forming the film by pinching between the first rotating member and the second rotating member, the step of:

conveying the film by a third rotating member. 3. The method of manufacturing an optical film of 2, comprising the step of:

stretching the film conveyed by the third rotating member

4. The method of manufacturing an optical film of 2, wherein a forth rotating member is pressed against the third rotating member with the film pinched therebetween.

5. The method of manufacturing an optical film of 4, wherein a pressing pressure of the forth rotating member is from 0.1 to 100 N/mm.

6. The method of manufacturing an optical film of 1, comprising, before the step of extruding, the step of:

drying to reduce volatile component in at least either of the additive agent and the cellulose resin.

. The method of manufacturing an optical film of 6, wherein in the step of drying, a material to be dried is heated to a temperature equal to or less than a glass transition point of the material to be dried.

8. The method of manufacturing an optical film of any one of 1 to 7, wherein a width of the cellulose resin extruded from the melt-casting die is from 1500 to 4000 mm.

9. The method of manufacturing an optical film of any one of 1 to 7; wherein average thickness of the film is made to be from 15 μm to 80 μm in the step of forming the film by pinching between the first rotating member and the second rotating member is.

10. An optical film manufactured by the method of any one of 1 to 7.

### EFFECTS OF THE INVENTION

The present invention provides an optical film manufacturing method including a step for sandwiching and pressing between the first and second rotating members, wherein the temperature of the film-like cellulose resin sandwiched and pressed between the first and second rotating members is equal to or higher than the melting point of the additive, and the line pressure of sandwiching and pressing between the first and second rotating members is in the range of 0.1 through 100 N/mm, whereby the roll can be effectively cleaned at a reduced cost. The present invention also provides an optical film manufactured using this manufacturing method with reduced contamination.

### BRIEF DESCRIPTION OF THE DRAWINGS

FIG. 1 is a schematic flow sheet showing an embodiment of the apparatus for implementing the optical film manufacturing method of the present invention;

FIG. 2 is a flow sheet showing an enlarged view of the major components of the manufacturing apparatus of FIG. 1;

FIG. 3 is a cross sectional view showing an example of a second rotating member;

FIG. 4 is a plan view showing an example of a second rotating member; and

FIG. 5 is a perspective exploded view showing the overview of the schematic diagram of a liquid crystal display apparatus.

### REFERENCE NUMERALS

1. Extruder
2. Filter
3. Static mixer
4. Flow-casting die (T-die)
5. First rotating member (first roll)
6. Second rotating member (second roll)
7. Third rotating member (second cooling roll)
7a. Fourth rotating member
8. Fifth rotating member (third cooling roll)
9. Separation roll
10. Pre-stretched film
12. Stretching machine
16. Winder
F. optical film (raw fabric roll)
21a. Protective film
21b. Protective film
22a. Phase difference film
22b. Phase difference film
23a. Slow axis direction of film
23b. Slow axis direction of film
24a. Transmission axis direction of polarizer
24b. Transmission axis direction of polarizer
25a. Polarizer
25b Polarizer
26a. Polarizing plate
26b. Polarizing plate
27. Liquid crystal cell
29. Liquid crystal display apparatus

### BEST MODE FOR CARRYING OUT THE INVENTION

Referring to the drawings, the following describes the details of the best embodiment for embodying the present invention, without the present invention being restricted thereto.

The present invention relates to the optical film manufacturing method that can be used especially in the protective film for the polarizing plate of a liquid crystal display apparatus (LCD).

The optical film as an object of the present invention refers to a functional film used in various types of displays such as a liquid crystal display (LCD), plasma display and organic electroluminescent display—especially in a liquid crystal display. It includes a polarizing plate protective film, phase difference film, antireflection film, brightness enhancing film, and optical compensation film with enlarged viewing angle—especially a phase difference film.

The optical film manufacturing method of the present invention is based on the melt-casting film forming method. In the melt-casting film forming method, cellulose resin including additive agent is heated. When the material has been fluidized, the aforementioned material is melt-extruded onto a cooling roll (e.g., cooling drum) or an endless belt, whereby a film is formed.

The melt-casting method is extremely different from the solution casting method in the following fact: When a film is formed by the melt-casting film forming method, the presence of volatile components in the cast resin will adversely affect the flatness and transparency of the film which is to be utilized as an optical film. This is because entry of volatile components in the produced film will reduce the transparency, and will cause a streak (die line) on the film surface when a film is formed through extrusion from a die-slit, with the result that the flatness may deteriorate. For this reason, when resin including additive agent is processed to form a film, for the purpose of avoiding generation of volatile components at the time of thermal melting, it is preferred to eliminate the presence of the component that volatilizes in the range of temperature lower than the melting temperature in film formation.

The volatile component includes the moisture absorbed, for example, by the cellulose resin including additive agent and the solvent mixed before purchase of the material or at the time of synthesis. Volatilization is caused by the evaporation, sublimation or decomposition resulting from heating of these components. The solvent described here is not a solvent in which the resin is solved for solution casting, but a solvent contained, in minute amount, in the cellulose resin including additive agent.

The material constituting the optical film as the embodiment of the present invention includes the cellulose resin as a dominant component and organic compositions, as additive agents, such as a stabilizer and plasticizer, an ultraviolet absorber, and a retardation controlling agent. These materials are selected depending on the required characteristics of the optical film.

The cellulose resin constituting the optical film of the present invention has the structure of a cellulose ester. It is amorphous and is independent or mixed acid ester of cellulose (hereinafter simply referred to as cellulose resin) including the structure of at least any one of the following materials: aliphatic acyl group and substituted or unsubstituted aromatic acyl group. The term “amorphous” refers to the state of a solid substance not in crystallized molecule arrangement but in irregular molecule arrangement. It represents the status of crystallization in the form of a raw material.

The following illustrates an example of the cellulose resin preferably used in the embodiment of the present invention, without the present invention being restricted thereto.

When the cellulose resin includes an aromatic acyl group, and the aromatic ring is a benzene ring, the substituent group of the benzene ring is exemplified by a halogen atom, cyano, alkyl group, alkoxy group, aryl group, aryloxy group, acyl group, carbonamide group, sulfonamide group, ureido group, aralkyl group, nitro, alkoxy carbonyl group, aryloxy carbonyl group, aralkyloxy carbonyl group, carbamoyl group, sulfamoyl group, acyloxy group, alkenyl group, alkynyl group, alkylsulfonyl group, arylsulfonyl group, alkyloxy sulfonyl group, aryloxy sulfonyl group, alkylsulfonyloxy group and aryloxysulfonyl group, —S—R, —NH—CO—OR, —PH—R, —P(—R)₂, —PH—O—R, —P(—R) (—OR), —P(O—R)₂, —PH(═O)—R—P(═O) (—R)₂, —PH(═O)—O—R, —P(═O) (—R) (—O—R), —P(═O) (—O—R)₂, —O—PH(═O)—R, —O—P(═O) (—R)₂—O—PH(═O)—O—R, —O—P(═O) (—R) (—O—R), —P(═O) (—O—R)₂, —NH—PH(═O)—R, —NH—P(═O) (—R) (—O—R), —NH—P(═O) (—O—R)₂, —SiH₂—R, —SiH(—R)₂, —Si(—R)₃, —O—SiH₂—R, —O—SiH(—R)₂ and —O—Si(—R)₂. The aforementioned R is an aliphatic group, aromatic group or heterocyclic group.

The number of the substituents is 1 through 5, preferably 1 through 4, more preferably 1 through 3, still more preferably 1 or 2. When the number of the substituents to replace the aromatic ring is two or more, they can be the same or different from one another, but they can be combined to form a condensed polycyclic compound (e.g., naphthalene indene, indan, phenanthrene, quinoline, isoquinoline, chromene, chromane, phthalazine, acridine, indole and indoline).

Halogen atom, cyano, alkyl group, alkoxy group, aryl group, aryloxy group, acyl group, carbonamide group, sulfone amide group and ureido group are preferably used as the substituent. Halogen atom, cyano, alkyl group, alkoxy group, aryloxy group, acyl group and carbonamide group are more preferably used. The halogen atom, cyano, alkyl group, alkoxy group and aryloxy group are still more preferably used, and the halogen atom, alkyl group and alkoxy group are most preferably used.

The aforementioned halogen atom includes a fluorine atom, chlorine atom, bromine atom and iodine atom.

The aforementioned alkyl group may be either cyclic or branched. The alkyl group contains preferably 1 through 20 carbon atoms, more preferably 1 through 12, still more preferably 1 through 6, most preferably 1 through 4.

The aforementioned alkyl group is exemplified by methyl, ethyl, propyl, isopropyl, butyl, t-butyl, hexyl, cyclo hexyl, octyl and 2-ethylhexyl

The aforementioned alkoxy group may be either cyclic or branched. The alkoxy group contains preferably 1 through 20 carbon atoms, more preferably 1 through 12, still more preferably 1 through 6, most preferably 1 through 4. The alkoxy group may be replaced by still another alkoxy group. The alkoxy group is exemplified by methoxy, ethoxy, 2-methoxyethoxy, 2-methoxy-2-ethoxyethoxy, butyloxy, hexyloxy and octyloxy.

The aforementioned aryl group contains preferably 6 through 20 carbon atoms, more preferably 6 through 12. The aryl group is exemplified by phenyl and naphthyl. The aforementioned aryloxy group contains preferably 6 through 20 carbon atoms, more preferably 6 through 12.

The aforementioned aryloxy group is exemplified by phenoxy and naphtoxy. The acyl group contains preferably 1 through 20 carbon atoms, more preferably 1 through 12.

The aforementioned acyl group is exemplified by formyl, acetyl and benzoyl. The aforementioned carbonamide group contains preferably 1 through 20 carbon atoms, more preferably 1 through 12.

The aforementioned carbonamide group is exemplified by acetoamide and benzamide. The aforementioned sulfone amide group contains preferably 1 through 20 carbon atoms, more preferably 1 through 12.

The aforementioned sulfone amide group is exemplified by methane sulfone amide, benzene sulfone amide and p-toluene sulfone amide. The aforementioned ureido group contains preferably 1 through 20 carbon atoms, more preferably 1 through 12.

The aforementioned ureido group is exemplified by (unsubstituted) ureido.

The aforementioned aralkyl group contains preferably 7 through 20 carbon atoms, more preferably 7 through 12. The aralkyl group is exemplified by benzyl, phenethyl and naphthylmethyl.

The aforementioned alkoxy carbonyl group contains preferably 1 through 20 carbon atoms, more preferably 2 through 12. The alkoxy carbonyl group is exemplified by methoxy carbonyl.

The aforementioned aryloxy carbonyl group contains preferably 7 through 20 carbon atoms, more preferably 7 through 12. The aryloxy carbonyl group is exemplified by phenoxy carbonyl.

The aforementioned aralkyloxy carbonyl group contains preferably 8 through 20 carbon atoms, more preferably 8 through 12. The aralkyloxy carbonyl group is exemplified by benzyloxy carbonyl.

The aforementioned carbamoyl group contains preferably 1 through 20 carbon atoms, more preferably 1 through 12. The carbamoyl group is exemplified by (unsubstituted) carbamoyl and N-methylcarbamoyl.

The aforementioned sulfamoyl group contains preferably 20 or less carbons, more preferably 12 or less carbons. The sulfamoyl group is exemplified by (unsubstituted) sulfamoyl and N-methylsulfamoyl. The aforementioned acyloxy group contains preferably 1 through 20 carbon atoms, more preferably 2 through 12.

The aforementioned acyloxy group is exemplified by acetoxy and benzoyloxy.

The aforementioned alkenyl group contains preferably 2 through 20 carbon atoms, more preferably 2 through 12. The alkenyl group is exemplified by vinyl, alyl and isopropenyl.

The aforementioned alkynyl group contains preferably 2 through 20 carbon atoms, more preferably 2 through 12. The alkynyl group is exemplified by thienyl. The aforementioned alkyl sulfonyl group contains preferably 1 through 20 carbon atoms, more preferably 1 through 12.

The aforementioned aryl sulfonyl group contains preferably 6 through 20 carbon atoms, more preferably 6 through 12.

The aforementioned alkyloxy sulfonyl group contains preferably 1 through 20 carbon atoms, more preferably 1 through 12.

The aforementioned aryloxy sulfonyl group contains preferably 6 through 20 carbon atoms, more preferably 6 through 12.

The aforementioned alkylsulfonyloxy group contains preferably 1 through 20 carbon atoms, more preferably 1 through 12.

The aforementioned aryloxysulfonyl group contains preferably 6 through 20 carbon atoms, more preferably 6 through 12.

In the cellulose resin used in the present invention, when the hydrogen atom of the hydroxyl group of cellulose is a fatty acid ester aliphatic acyl group, the examples include aliphatic acyl group containing 2 through 20 carbon atoms. To put it more specifically, examples are acetyl, propionyl, butyryl, isobutyryl, valeryl, pivaloyl, hexanoyl, octanoyl, lauroyl and stearoyl.

In the present invention, the aforementioned aliphatic acyl group includes the group containing a further substituent. The substituent can be exemplified by those mentioned as substituents of the benzene ring when the aromatic ring is a benzene ring in the aforementioned aromatic acyl group.

When a phase difference film is to be manufactured as the optical film, at least one substance selected from among the cellulose acetate, cellulose propyonate, cellulose butylate, cellulose acetate propyonate, cellulose acetate butylate, cellulose acetate phthalate, and cellulose phthalate is preferably used as the cellulose resin. Alternatively, the preferably used one is the biodegradable cellulose derivative hybrid graft polymerizer formed by ring opening hybrid graft polymerization between lactone and lactide by addition of a ring opening polymerization catalyst of cyclic ester in the presence of the cellulose derivative described in Japanese Patent No. 3715100. Especially the lactone is preferably the one selected from among the groups made up of β-propiolactone, δ-valerolactone, ε-caprolactone, α,α-dimethyl-β-propiolactone, β-ethyl-δ-valerolactone, α-methyl-ε-caprolactone, β-methyl-ε-caprolactone, γ-methyl-ε-caprolactone and 3,3,5-trimethyl-ε-caprolactone. The cellulose derivative is exemplified by cellulose ester such as cellulose diacetate, cellulose acetate butylate, cellulose acetate propyonate, cellulose acetate phthalate and cellulose nitrate, or cellulose ether such as ethylcellulose, methylcellulose, hydroxypropylcellulose and hydroxypropylmethylcellulose. They can be produced according to the method disclosed in Japanese Patent No. 3715100.

In these substances, the particularly preferred cellulose resin is exemplified by cellulose acetate, cellulose propyonate, cellulose butylate, cellulose acetate propyonate and cellulose acetate butylate.

The cellulose acetate propyonate as fatty acid ester and cellulose acetate butylate have an acyl group containing 2 through 4 carbon atoms as a substituent. Assume that the acetyl group has a replacement ratio of X, and the propionyl group or butyryl group has a replacement ratio of Y. In this case, both the following relationships (I) and (II) are preferably met at the same time. The replacement ratio is defined as the numerical value wherein the number of the hydroxyl groups replaced by the acyl group is represented in terms of glucose unit.

Relationship (I) 2.5≦X+Y≦3.0

Relationship (II) 0≦X≦2.5 and 0.3≦Y≦2.5

preferably 0.5≦X≦2.5 and 0.5≦Y≦2.5

more preferably 1.0≦X≦2.0 and 1.0≦Y≦2.0

Particularly the cellulose acetate propyonate is preferably used. The portion not replaced by the aforementioned acyl group is normally present as a hydroxyl group. They can be synthesized by a known method. The cellulose material of the cellulose resin used in the present invention can be a wood pulp or cotton linter. The wood pulp can be a conifer or a broad-leaved tree. The conifer is more preferred. From the viewpoint of separability at the time of film formation, use of the cotton linter is more preferred. The cellulose resins produced therefrom can be used in a mixed form or independently.

The cellulose resin containing a smaller amount of bright spot defects when formed into a film is more preferably used in the present invention. Bright spot defects are defined as foreign substances that cause light leakage when observation is made from the position perpendicular to one polarizing plate in a following arrangement: Two polarizing plates are arranged perpendicular to each other (crossed-Nichol), a cellulose ester film is placed between them, the slow axis of the polarizing plate protective film lies parallel to the transmission axis of the other polarizing plate on the light source side. In this case, the polarizing plate used for evaluation is preferably

The melt-casting film forming method including the step for filtering out bright spot defects by thermal melting is more preferable for the system where the plasticizer (to be described later) and cellulose resin make a composition than the system where the plasticizer is not added, in the terms of reducing the thermal melting temperature, improving the removing efficiency of bright spot defects and avoiding thermal decomposition. It is also possible to filter a composition added, if required, with an ultraviolet absorber and matting agent as other additives (to be described later).

Conventionally known materials are preferably used as filter media exemplified by a glass fiber, cellulose fiber, filter paper, and fluorine resin such as ethylene tetrafluoride. In particular, ceramics and metals are more preferably used. The absolute filtration accuracy of the used materials is equal to or less than 50 μm, preferably equal to or less than 30 μm, more preferably equal to or less than 10 μm, still more preferably equal to or less than 5 μm. They can be combined for use, if required. Either the surface type or depth type can be used as the filter medium, but the depth type is more preferably used because it is more difficult to be clogged.

In another embodiment, it is possible to similarly remove bright foreign substance, in a solution state before heating and dissolving the cellulose resin containing additive agents, defects through the filtration step in at least one of the processes of the latter period of synthesizing the material and obtaining precipitates. In this case, a stabilizer is preferably present in the made of the protective film free from bright spot defects. Here a glass plate is preferably used to protect the polarizer. The unreacted esterified portion of the hydroxyl group contained in the cellulose resin is considered as one of the factors causing bright spot defects. Bright spot defects can be reduced by using the cellulose resin containing a reduced amount of bright spot defects, and by removing the foreign substance through filtration of heat-molten cellulose resin. The number of bright spot defects per unit area can be reduced by reducing the thickness of the film. As the amount of the cellulose resin contained in the film decreases, the amount of bright spot defect tends to be smaller.

When observed in the state of crossed-Nichol, the numbers of bright spots are preferably 300 or less per area of 250 mm² for the bright spots with a size of 5 through 50 μm and 200 or less for the bright spots with a size of 50 μm or more. More preferably, the number of bright spots with a size of 5 through 50 μm does not exceed 200.

An excessive number of bright spots have an adverse affect on an image on the liquid crystal display. When a phase difference film is used as a polarizing plate protective film, the bright spots causes a disorder in birefringence, thereby resulting in images being seriously affected.

When bright spot defects are removed by melting and filteration, it is possible to implement a continuous melt-casting film forming step including the step for removing bright spot defects. cellulose resin. Further, it is also possible to take steps wherein the resin is dissolved in the solvent together with the plasticizer (to be described later), ultraviolet absorber, and matting agent added as other additives (to be described later) before the solvent is removed to dry, thereby obtaining the solids of cellulose resin containing the additive.

Further, a step being cooled down to −20° C. can be inserted in the process where the cellulose resin containing the additive agents is dissolved in the solvent to make the aforementioned solution state. When the additive agent is added into the cellulose resin, during the step for synthesizing (preparing) the cellulose resin used in the present invention, filtration can be performed to filter out bright foreign substances and insoluble matters at least once in the solution state, without being restricted thereto, before the latter period of the resin synthesizing (preparing) period. After that, the additive agent can be added and the solids can be separated by removal of the solvent or acid segregation. It can also be possible to get the cellulose resin including the additive mixed with powder at the time of pelletization.

Uniformly mixing the additive agent of the present invention with cellulose resin effectively helps the material to melt uniformly at the time of heating.

As an additive agent of the present invention, polymer material or oligomer can be selected to be mixed with the cellulose resin. Such a polymer material and oligomer are preferred to have a high degree of compatibility with the cellulose resin so that when a film is formed, the transmittance is 80% or more over the entire visible range (400 nm through 800 nm) preferably 90% or more, and more preferably 92% or more. The purpose of mixing in at least one of the materials of polymer material other than cellulose resin and oligomer includes improving the controllability of viscosity at the time of thermal melting and physical properties of the processed film.

At least one of the stabilizers is added to the cellulose resin before or at the time of thermal melting of the aforementioned cellulose resin. The stabilizer is required to function without being decomposed at the melting temperature for film formation.

The stabilizer includes a hindered phenol antioxidant, acid-acceptor, hindered amine light stabilizer, peroxide decomposer, radical acceptor, metal deactivator and amines. They are disclosed in the Japanese Laid-Open Patent Publication No. H03-199201, Japanese Laid-Open Patent Publication No. H05-1907073, Japanese Laid-Open Patent Publication No. H05-194789, Japanese Laid-Open Patent Publication No. H05-271471, and Japanese Laid-Open Patent Publication No H06-107854.

The stabilizer of the present invention is used to prevent oxidation of the film constituting material, to capture the acid produced by decomposition, to prevent or inhibit decomposition caused by radical species due to light or heat, and to control generation of volatile component caused by the degeneration represented by coloring or a reduction in molecular weight or material decomposition, including the decomposition reaction yet to be clarified. To be more specific, addition of stabilizer to the cellulose resin is very effective in controlling or preventing generation of the volatile component resulting from degeneration and decomposition. Further, the stabilizer itself is required not to generate a volatile component in the range of temperature for melting the cellulose resin.

When a phase difference film is manufactured, addition of a stabilizer is preferred. In the step of providing retardation as a phase difference film in the production of a film, the stabilizer minimizes reduction in the deterioration of the strength of the cellulose resin containing the additive agent, or maintains the strength inherent to the material. This is because when the cellulose resin maintaining the stabilizer may get brittle by considerable deterioration, breakage easily occurs in the step of orientation at the time of film formation, thereby preventing the phase difference film from having the retardation value expected for the phase difference film.

Further, the presence of the stabilizer is preferable because it reduces generation of a colored object in the visible light range at the time of thermal melting, and reduces or removes the undesirable characteristics for the phase difference film, in transmittance or haze value, caused by entry of the volatile component into the film. The haze value is less than 1%, preferably less than 0.5%.

In the cellulose storing or film making process, deterioration may also be caused by the presence of oxygen in the air. In this case, means can be provided to reduce the density of oxygen in the air, in addition to the method of using the stabilizing function of the stabilizer. Such means can be exemplified by the known technology of using the nitrogen or argon as an inert gas, deaeration such as reduced pressure or vacuum, or operation in an enclosed environment. At least one of these three methods can be used together with the method wherein the aforementioned stabilizer is present. Deterioration of the aforementioned material can be reduced by lowering the probability of the cellulose resin containing the additive agent contacting the oxygen in the air.

When the phase difference film is used as a polarizing plate protective film, the aforementioned stabilizer is incorporated in the cellulose resin containing the additive agent in terms of improving the storage stability over time of the polarizer constituting the polarizing plate and polarizer

In the liquid crystal display apparatus using a polarizing plate, presence of the aforementioned stabilizer in the phase difference film improves the storage stability over time of the phase difference film and provides the optical compensation function for a long period of time.

A known compound can be used as the hindered phenol antioxidant compound, as the additive agent of the present inventions contributing to stabilization at the time of thermal melting the cellulose resin. It is exemplified by a 2,6-dialkyl phenol derivative compound including the compound disclosed in the 12th through 14th columns of the Specification in the U.S. Pat. No. 4,839,405. Such compound includes the compound defined by the following general formula (1).

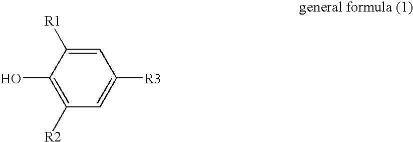

In the formula, R1, R2, and R3 denote the alkyl substituent that is further replaced or is not replaced. The examples of hindered phenol compounds include: n-octadecyl 3-(3,5-di-t-butyl-4-hydroxy phenyl)-propionate, n-octadecyl 3-(3,5-di-t-butyl-4-hydroxy phenyl)-acetate, n-octadecyl 3,5-di-t-butyl-4-hydroxy benzoate, n-hexyl 3,5-di-t-butyl-4-hydroxy phenyl benzoate, n-dodecyl 3,5-di-t-butyl-4-hydroxy phenyl benzoate, neo-dodecyl 3-(3,5-di-t-butyl-4-hydroxy phenyl) propionate, dodecyl β (3,5-di-t-butyl-4-hydroxy phenyl) propionate, ethyl α-(4-hydroxy-3,5-di-t-butylphenyl) isobuylate; octadecyl α-(4-hydroxy-3,5-di-t-butylphenyl) isobuylate, octadecyl α-(4-hydroxy-3,5-di-t-butyl-4-hydroxy phenyl) propionate, 2-(n-octylthio)ethyl 3, 5-di-t-butyl-4-hydroxy benzoate, 2-(n-octylthio)ethyl 3,5-di-t-butyl-4-hydroxy-phenyl acetate, 2-(n-octadecylthio)ethyl 3,5-di-t-butyl-4-hydroxy-phenyl acetate, 2-(n-octadecylthio)ethyl 3,5-di-t-butyl-4-hydroxy benzoate, 2-(2 hydroxyethylthio)ethyl 3,5-di-t-butyl-4-hydroxy benzoate diethyl glycol bis-(3,5-di-t-butyl-4-hydroxy phenyl) propionate, 2-(n-octadecylthio)ethyl 3-(3,5-di-t-butyl-4-hydroxy-phenyl) propionate, stearamide N,N-bis-[ethylene 3-(3,5-di-t-butyl-4-hydroxy phenyl) propionate], n-butylimino N,N-bis-[ethylene 3-(3,5-di-t-butyl-4-hydroxy phenyl) propionate]/2-(2-stearoyl oxyethylthio)ethyl 3,5-di-t-butyl-4-hydroxy benzoate, 2-(2-stearoyl oxyethylthio) ethyl 7-(3-methyl-5-di-t-butyl-4-hydroxy phenyl) heptanoate, 1,2-propylene glycol bis-[3-(3,5-di-t-butyl-4-hydroxy phenyl) propionate], ethylene glycol bis-[3-(3,5-di-t-butyl-4-hydroxy phenyl) propionate], neopentyl glycol bis-[3-(3,5-di-t-butyl-4-hydroxy phenyl) propionate], ethylene glycol bis-(3,5-di-t-butyl-4-hydroxy phenyl acetate), glycerine-1-n-octdecanoate-2,3-bis-(3,5-di-t-butyl-4-hydroxy phenyl acetate), pentaerythritol-tetra kis-[3-(3′,5′-di-t-butyl-4′-hydroxy phenyl)propionate]1,1,1-trimethylol ethane tris-[3(3,5-di-t-butyl-4-hydroxy phenyl)propionate], sorbitol hexa-([3(3,5-di-t-butyl-4-hydroxy phenyl)propionate], 2-hydroxyehyl 7-(3-methyl-5-t-butyl-4-hydroxy phenyl) propionate, 2-stearoyl oxyethyl 7-(3-methyl-5-t-butyl-4-hydroxy phenyl) heptanoate, 1,6-n-hexane diol-bis[(3′,5′-di-t-butyl-4-hydroxy phenyl) propionate], and pentaerythritol-tetra kis (3,5-di-t-butyl-4-hydroxy hydrocinnamate).

The hindered phenol based antioxidant compound is on the market, for example, under the trade name of “Irganox 1076” and “Irganox 1010” manufactured by Ciba Specialty Chemicals K.K.

An acid-acceptor (as the additive agent of the present invention) contributing to stabilization at the time of thermal melting preferably includes epoxy compound described in the Specification of the U.S. Pat. No. 4,137,201. Such a compound is already known in the aforementioned technical field. It is exemplified by the diglycidyl ether of various polyglycols; polyglycol induced by condensation of about 8 through 40 moles of ethylene oxide per mole of polyglycol in particular; a metallic epoxy compound such as diglycidyl ether of glycerol (e.g. the compound having been used so tar together with polyvinyl chloride polymer composition in the polyvinyl chloride polymer composition); epoxidized ether condensed product; diglycidyl ether of the bisphenol A (e.g., 4,4′-dihydroxydiphenyl dimethyl methane); epoxidized unsaturated fatty acid ester (particularly, the alkyl ester containing about 4 through 2 carbon atoms of the fatty acid of this carbon atom having about 2 through 22 (e.g., butyl epoxy stearate); and various epoxidized long chain fatty acid triglyceride (e.g., epoxidized plant oil and other unsaturated natural gas (sometimes called the epoxidized natural glyceride or unsaturated fatty acid wherein these fatty acid generally contain 12 through 22 carbon atoms)) represented and illustrated by the compound of epoxidized soy bean oil). The most preferable materials include commercial epoxy group containing epoxide resin compound EPON815c and epoxidized ether condensed oligomer product defined by the general formula (2).

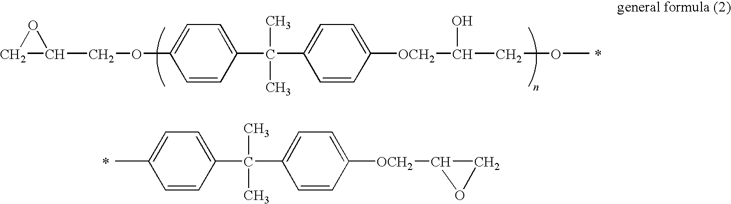

In the formula, n is in the range of 0 through 12.

Examples of the acid-acceptor that can be used further include the ones described in the paragraphs 87 through 105 of the Japanese Laid-Open Patent Publication No. H5-194788.

A known compound can be used as the hindered amine light stabilizer (HALS) contributing to the stabilization at the time of thermal melting of the cellulose resin. To put it more specifically, it is exemplified by 2,2,6,6-tetraalkyl piperidine compound, the acid added salt thereof, or the complex between the same and metallic compound, as described in the columns 5 through 11 of the Specification of the U.S. Pat. No. 4,619,956 and in the columns 3 through 5 of the Specification of the U.S. Pat. No. 4,839,405. Such compounds include the material defined by the following general formula (3).

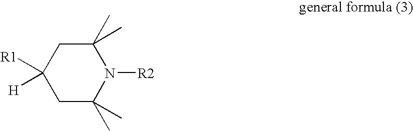

In the formula, R1 and R2 denote the H or substituent.

The examples of a hindered amine light stabilizer compound include: 4-hydroxy-2,2,6,6-tetramethyl piperidine, 1-allyl-4-hydroxy-2,2,6,6-tetramethyl piperidine, 1-benzyl-4-hydroxy-2,2,6,6-tetramethyl piperidine, 1-(4-t-butyl-2-butenyl)-4-hydroxy-2,2,6,6-tetramethyl piperidine, 4-stearoyloxy-2,2,6,6-tetramethyl piperidine, 1-methyl-4-salicyloyloxy-2,2,6,6-tetramethyl piperidine, 4-methacryloyloxy-1,2,2,6,6-pentamethyl piperidine, 1,2,2,6,6-pentamethyl piperidine-4-yl-β-(3,5-di-t-butyl-4-hydroxy phenyl)-propionate, 1-benzyl-2,2,6,6-tetramethyl-4-piperidinyl maleinate, (di-2,2,6,6-tetramethyl piperidine-4-yl)-adipate, (di-2,2,6,6-tetramethyl piperidine-4-yl)-sebacate, (di-1,2,3,6-tetramethyl-2,6-diethyl-piperidine-4-yl)-sebacate, (di-1-allyl-2,2,6,6-tetramethyl piperidine-4-yl)-phthalate, 1-acetyl-2,2,6,6-tetramethyl piperidine-4-yl-acetate, trimellitic acid-tri-(2,2,6,6-tetramethyl piperidine-4-yl) ester, 1-acryloyl-4-benzyloxy-2,2,6,6-tetramethyl piperidine, dibutyl-malonic acid-di-(1,2,2,6,6-pentamethyl piperidine-4-yl)-ester, dibenzyl-malonic acid-di-(1,2,3,6-tetramethyl-2,6-diethyl-piperidine-4-yl)-ester, dimethyl-bis-(2,2,6,6-tetramethyl piperidine-4-oxy) silane, tris-(1-propyl-2,2,6,6-tetramethyl piperidine-4-yl)-phosphite, tris (1-propyl-2,2,6,6-tetramethyl piperidine-4-yl)-phosphate, N,N′-bis-(2,2,6,6-tetramethyl piperidine-4-yl)-hexamethylene-1,6-diamine, N,N′-bis-(2,2,6,6-tetramethyl piperidine-4-yl)-hexamethylene-1,6-diacetoamide, 1-acetyl-4-(N-cyclohexylacetoamide)-2,2,6,6-tetramethyl piperidine, 4-benzylamino-2,2,6,6-tetramethyl piperidine, N,N′-bis-(2,2,6,6-tetramethyl piperidine-4-yl)-N,N′-dibutyl-adipamide, N,N′-bis-(2,2,6,6-tetramethyl piperidine-4-yl)-N,N′-dicyclohexyl-(2-hydroxy propylene), N,N′-bis-(2,2,6,6-tetramethyl piperidine-4-yl)-p-xylylene-diamine, 4-(bis-2-hydroxyethyl)-amino-1,2,2,6,6-pentamethyl piperidine, 4-methacrylamide-1,2,2,6,6-pentamethyl piperidine, and α-cyano-β-methyl-β-[N-(2,2,6,6-tetramethyl piperidine-4-yl)]-amino-methyl acrylate ester. The examples of the preferred hindered amine light stabilizers include the following HALS-1 AND HALS-2.

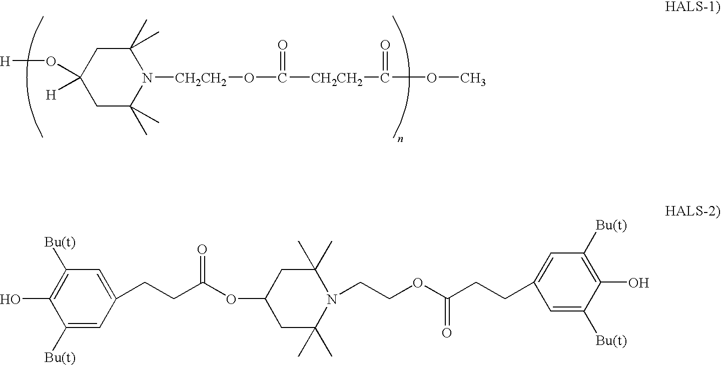

At least one of the stabilizer types can be selected and added as the additive agent of the present invention. The amount to be added is preferably 0.001W by mass or more without exceeding 5% by mass with respect to the mass of the cellulose resin, more preferably 0.005% by mass or more without exceeding 3% by mass, still more preferably 0.01% by mass or more without exceeding 0.8% by mass.

If the amount of the stabilizer to be added is to little, the advantages of the stabilizer cannot be sufficiently used due to a lower effect of stabilization at the time of thermal melting. If the amount of the stabilizer to be added is excessive, on the other hand, film transparency will be reduced at a point of view of compatibility with resin, and the film is made to be brittle. This is not preferable.

The stabilizer is preferably mixed before melting the resin. A mixer may be used for this purpose, alternatively, mixing may be made in the cellulose resin preparation phase as described above. Mixing may be done at a temperature lower than the melting point of the resin and higher than that of the stabilizer so that only the stabilizer is melted and is adsorbed on the surface of the resin.

Addition of the plasticizer is preferred for the purpose of improving the film quality such as improving mechanical properties, providing softness, and reducing water absorption properties and moisture permeability.

In the melt-casting film forming method practiced in the present invention, use of a plasticizer is intended to reduce the melting temperature of cellulose resin containing additive agent below the glass transition temperature of the single cellulose resin, or to reduce the viscosity of cellulose resin containing additive agent including plasticizer below that of the single cellulose resin at the same heating temperature.

The melting temperature of cellulose containing additive agent, in the present invention, refers to the temperature at which the heated resin has flowability.

When only cellulose resin is used and the temperature is lower than the glass transition temperature, the material is not sufficiently fluidized to form a film. However, the modulus of elasticity or viscosity of the aforementioned resin is reduced by absorption of heat at the glass transition temperature or more, and the material is fluidized. To lower the melting temperature of cellulose resin, the plasticizer as the additive agent preferably has a melting point or a glass transition temperature lower than the glass transition temperature of the cellulose resin to achieve the aforementioned object.

For example, a phosphoric acid ester derivative and carboxylic acid ester derivative are preferably used as a plasticizer for the additive agent of the present invention. It is also preferred to use the polymer obtained by polymerization of the ethylenic unsaturated monomer having a mass average molecular weight of 500 or more without exceeding 10,000 mentioned in the Japanese Laid-Open Patent Publication No. 2003-12859, the acryl based polymer, the acryl based polymer having an aromatic ring on the side chain, or acryl based polymer having the cyclohexyl group on the side chain.

The phosphoric acid ester derivative is exemplified by triphenyl phosphate, tricresyl phosphate and phenyldiphenylphosphate.

The carboxylic acid ester derivative is exemplified by phthalic acid ester and citric acid ester. The phthalic acid ester derivative is exemplified by dimethylphthalate, diethylphthalate, dicyclohexyl phthalate, dioctylphthalate and diethylhexylphthalate. The citric acid ester is exemplified by citric acid acetyl triethyl and citric acid acetyl tributyl.

Other substances preferably used for the aforementioned purpose are butyl oleate, methylacetyl ricinoleate, dibutyl sebacate, triacetin, trimethylol propane tribenzoate and others. Alkylphthalylalkylglycolate is also used for this purpose. The alkyl of the alkylphthalyl alkylglycolate is an alkyl group containing 1 through 8 carbon atoms. The alkylphthalyl alkylglycolate is exemplified by methylphthalyl methylglycolate, ethylphthalyl ethylglycolate, propylphthalyl propylglycolate, butylphthalyl butylglycolate, octylphthalyl octylglycolate, methylphthalyl ethylglycolate, ethylphthalylmethyl glycolate, ethylphthalylpropyl glycolate, propylphthalyl ethylglycolate, methylphthalyl propylglycolate, methylphthalyl butylglycolate, ethylphthalylbutyl glycolate, butylphthalyl methylglycolate, butylphthalyl ethylglycolate, propyl phthalyl butylglycolate, butylphthalyl propylglycolate, methylphthalyl octylglycolate, ethylphthalyloctyl glycolate, octylphthalyl methylglycolate and octylphthalyl ethylglycolate. Methylphthalyl methylglycolate, ethylphthalyl ethylglycolate, propylphthalyl propylglycolate, butylphthalyl butylglycolate and octylphthalyl octylglycolate are preferably used. In particular, ethylphthalyl ethylglycolate is preferably used. Further, two or more of the alkylphthalyl alkylglycolate and others can be mixed for use.

The amount of the plasticizer to be added is preferably 0.5% by mass or more through 20% by mass exclusive, with respect to the resin constituted of the cellulose resin containing the additive agent, more preferably 1% by mass or more and less than 11% by mass.

The aforementioned plasticizer is preferred not to generate a volatile component at the time of thermal melting To put it more specifically, the nonvolatile phosphoric acid ester described in the Japanese Translation of PCT International Application Publication No. H06-501040 can be mentioned as an example. The arylene bis(diaryl phosphate) ester and trimethylol propane tribenzoate as the above illustrated compound can be preferably used, without being restricted thereto. When the volatile component is generated by the thermal decomposition of the plasticizer, and the thermal decomposition temperature Td (1.0) of the plasticizer is defined as the temperature at which the plasticizer is reduced by 1.0% by mass, it is required to be higher than the melting temperature (Tm) of the cellulose resin containing the additive agent. This is because the amount of the plasticizer to be added, to realize its purpose of addition, to the cellulose resin is greater than that of the cellulose resin containing other additive agents and the presence of the volatile component from this plasticizer has a serious impact on the deterioration of the quality of the film to be obtained. It should be noted that thermal decomposition temperature Td (1.0) can be measured by the commercially available differential thermogravimetric analyzer (TG-DTA).

For the purpose of preventing the polarizer and display apparatus from being deteriorated by ultraviolet light, the ultraviolet absorber as the additive agent of the present invention has an excellent function of absorbing the ultraviolet light with a wavelength of 370 nm or less. In addition, the absorber preferably absorbs a smaller amount of the visible light with a wavelength of 400 nm or more from the point of view of display performance. The ultraviolet absorber is exemplified by an oxybenzophenone based compound, benzotriazole based compound, salicylic acid ester based compound, benzophenone based compound, cyanoacrylate based compound and nickel complex salt based compound. The benzophenone based compound and benzotriazole based compound of less coloring are preferably used. It is also possible to use the ultraviolet absorber mentioned in the Japanese Laid-Open Patent Publication No. H10-182621 and Japanese Laid-Open Patent Publication No. H08-337574 and the polymer ultraviolet absorber described in the Japanese Laid-Open Patent Publication No. H06-148430.

The benzotriazole based ultraviolet absorber is exemplified by mixtures of 2-(2′-hydroxy-5′-methylphenyl) benzotriazole, 2-(2-hydroxy-3′,5′-di-tert-butylphenyl) benzotriazole, 2-(2′-hydroxy-3′-tert-butyl-5′-methylphenyl) benzotriazole, 2-(2′-hydroxy-3′,5′-di-tert-butylphenyl)-5-chlorobenzotriazole, 2-(2′-hydroxy-3′-(3″,4″,5″,6″-tetrahydrophthalimide methyl)-5′-methylphenyl) benzotriazole, 2,2-methylene bis(4-(1,1,3,3-tetramethylbutyl)-6-(2H-benzotriazole-2-yl) phenol), 2-(2′-hydroxy-3′-tert-butyl-5′-methylphenyl)-5-chlorobenzotriazole, 2-(2H-benzotriazole-2-yl)-6-(straight chain and side chain dodecyl)-4-methylphenol, octyl-3-[3-tert-butyl-4-hydroxy-5-(chloro-2H-benzotriazole-2-yl)phenyl]propyonate and 2-ethylhexyl-3-[3-tert-butyl-4-hydroxy-5-(5-chloro-2H-benzotriazole-2-yl)phenyl]propyonate, without being restricted thereto.

TINUVIN 109, TINUVIN 171, TINUVIN 326 (by Ciba Specialty Chemicals K.K.) is commercially available.

The benzophenone based compound is exemplified by 2,4-dihydroxybenzophenone, 2,2′-dihydroxy-4-methoxybenzophenone, 2-hydroxy-4-methoxy-5-sulfobenzophenone, and bis(2-methoxy-4-hydroxy-5-benzoylphenyl methane), without being restricted thereto.

The amount of the ultraviolet absorber to be added is 0.1 through 20% by mass with respect to the mass of cellulose resin, preferably 0.5 through 10% by mass, more preferably 1 through 5% by mass. Two or more types thereof can be added in combination.

The optical film of the present invention can be provided with a matting agent to improve properties of sliding, transportability and easy winding.

The matting agent made of more minute particles is more preferable. It is exemplified by inorganic particles and crosslinking polymer particles of silicon dioxide, titanium dioxide, aluminum oxide, zirconium oxide, calcium carbide, karyon, talc, sintered calcium silicate, hydrated calcium silicate, aluminum silicate, magnesium silicate and calcium phosphate.

Silicon dioxide in the aforementioned substances is preferable because the use of it reduces the degree of film haze. The particles such as silicon dioxide are often surface-treated by an organic substance. They are preferable because the use of them reduce the film haze.

The organic substance preferably used for surface-treated is exemplified by halosilane, alkoxy silane, silazane and siloxane. When the average particle size of the particle is greater, the sliding property effect is greater. Conversely, when the average particle size of the particle is smaller, the transparency is superior. Further, the average size of the secondary particle is 0.05 through 1.0 μm. The average size of the secondary particle is preferably 5 through 50 nm, more preferably 7 through 14 nm. The aforementioned particle is preferably used to form projections and depressions having a height of 0.01 through 10 μm on the film surface. The amount of particles contained therein is preferably 0.005 through 0.3% by mass with respect to the cellulose resin.

The particle of silicon dioxide is exemplified by AEROSIL 200, 200V, 300, R972, R972V, R974, R202, R812, OX50, and TT600 (by Nippon Aerosil Co., Ltd.). Of these, AEROSIL 200V, R972, R972V, R974, R202 and R812 are preferable. Two or more of these particles can be used. When two or more of these particles are used, they can be mixed for use in any mixing ratio. In this case, the mass ratio of the particles having different average particle sizes and different materials such as AEROSIL 200V and R972V can be used at the mass ratio of 0.1 to 99.9 through 99.9 to 0.1.

The matting agent is preferably added to cellulose resin containing additive agent before melting the cellulose resin, or is preferably included in the cellulose resin containing the additive agent in advance. For example, the matting agent is included in the cellulose resin containing the additive agent in advance by a precipitation method or a method in which the particles dispersed in a solvent in advance and/or other additive agents such as plasticizer and ultraviolet absorber are mixed and dispersed in the cellulose resin and the solvent is volatilized. Use of such cellulose resin containing additive agent provides uniform dispersion of the matting agent in the cellulose resin.

The particles in the film used as a matting agent also can improve the strength of the film.

For example, when a phase difference film is manufactured as an optical film, the retardation control agent can be added to adjust the retardation. As described in the Specification of European Patent 911,656A2, the aromatic compound having two aromatic rings can be used as a retardation control agent. Two or more types of aromatic compounds can be used in combination. The aromatic ring of the aforementioned aromatic compound includes an aromatic heterocycle in addition to the aromatic hydrocarbon ring. The aromatic heterocycle is particularly preferable. The aromatic heterocycle is generally an unsaturated heterocycle, and 1,3,5-triazine ring is particularly preferable.

When the stabilizer, plasticizer and the aforementioned other additives are added to the cellulose resin, the total amount of them, with respect to the mass of the cellulose resin, is made to be 1% by mass through 30% by mass, preferably 5 through 20% by mass.

In the melting process and film making process, the cellulose resin containing the additive agent of the present invention is required to produce only a small amount of volatile component or no volatile component at all. This is intended to reduce or avoid the possibility of foaming at the time of thermal melting and causing a defect inside the film and deterioration in the flatness on the film surface.

When the cellulose resin containing the additive agent of the present invention is melted, the percentage of the volatile component is desired to be 1% by mass or less, preferably 0.5% by mass or less, more preferably 0.2% by mass or less, still more preferably 0.1% by mass or less. In the present invention, reduction in weight by heating from 30° C. to 250° C. is measured by a differential thermogravimetric analyzer (TG/DTA200 by Seiko Electronic Industry Co., Ltd.), and the reduction amount is thought to be equivalent to the amount of the contained volatile component.

Before film formation or at the time of heating, the aforementioned moisture and volatile component represented by the aforementioned solvent is preferably removed from the cellulose resin, to be used, containing the additive agent of the present invention. It can be removed according to a known drying technique. Heating technique, reduced pressure technique or heating/pressure reduction technique can be utilized. The removing operation can be done in the air or under the atmosphere of nitrogen as inert gas. When the aforementioned known drying technique is used, the temperature should be in such a range that the cellulose resin containing the additive agent of the present invention is not decomposed, in order not to deteriorate the film quality.

Drying before formation of a film reduces the possibility of volatile components to be generated and make it possible to dry the resin singly or to dry the resin and the additive agent separately. The drying temperature is preferably 100° C. or more. If the material to be dried contains a substance having a glass transition temperature, and the material is heated higher than the glass transition temperature, the material may be welded and may become difficult to handle. Therefore, the drying temperature is preferably below the glass transition temperature. If a plurality of substances have glass transition temperatures, the lowest glass transition temperature is used as a standard. The drying temperature is preferably 100° C. or more without exceeding (glass transition temperature −5)° C., more preferably 110° C. or more without exceeding (glass transition temperature −20)° C. The drying time is preferably 0.5 through 24 hours, more preferably 1 through 18 hours, still more preferably 1.5 through 12 hours. If the drying temperature is too low, the volatile component removal rate will be reduced, and the drying time will be prolonged. Further, the drying process can be divided into two steps For example, the drying process may contain the steps: a preliminary drying step for drying the material for storage, and a drying step for drying the material at some point between right before and a week ahead of film formation.

The melt-casting film forming method can be classified into the molding method by thermal melting, which includes the melt extrusion molding method, press molding method, inflation method, injection molding method, blow molding method and stretching molding method. The melt extrusion method is the most preferable of them in order to ensure an optical film having excellent mechanical strength and surface accuracy. The following describes the film manufacturing method of the present invention taking the melt extrusion method as an example.

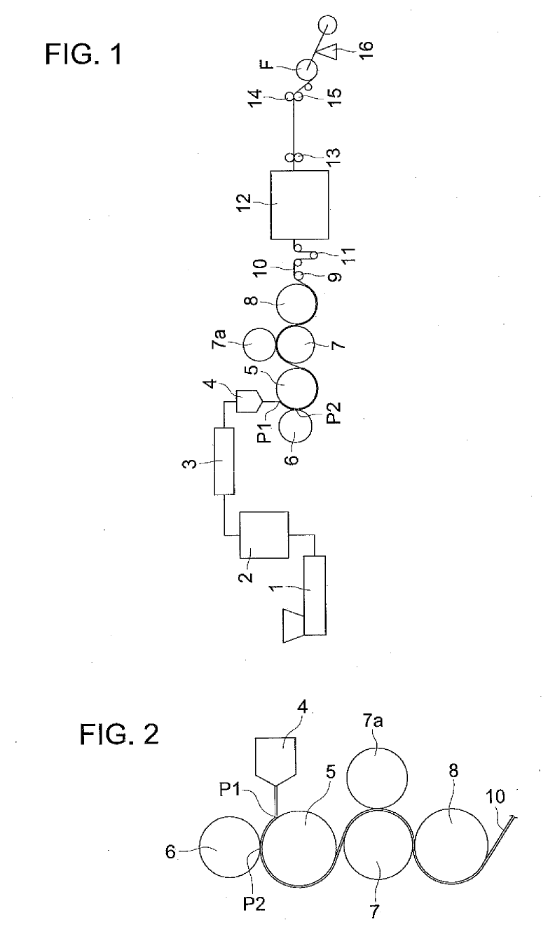

FIG. 1 is a schematic flow sheet of an apparatus in which the manufacturing method of the optical film of the present invention is practiced. FIG. 2 is an enlarged flow sheet representing the portion from the flow casting die to the cooling roll.

In the film manufacturing method of the present invention shown in FIGS. 1 and 2, the method is executed as follows; a film material such as a cellulose resin containing additive agent is mixed, the resin is extruded, by an extruder 1, onto a first roll 5 (cooling roll or cooling drum) as a first rotating member from a flow casting die 4 while it is melted, the cellulose resin in a molten film form is formed into a film by being circumscribed with the first cooling roll 5 (first cooling roll) and being pressed against the surface of the cooling roll 5 at a prescribed pressure by a second roll 6 (touch roll) as a second rotating member, the film is cooled down to be solid and becomes a pre-stretch film 10 by being contacted with the following rolls: a second cooling roll 7 as a third rotating member, a fourth roll 7a as a fourth rotating member, which pinches and presses the film between a second cooling roll and itself, and a third cooling roll 8 as a fifth rotating member, the pre-stretch film separated by a separation roll 9 is stretched in the width direction, by the stretching apparatus 12, with its both sides held, and the stretched film is wound by a winding apparatus 16.

In the optical film manufacturing method of the present invention, condition of the melt extrusion can be the same as those used for other thermoplastic resins including polyester. In this case, the material is preferably dried in advance. The moisture of the materials is preferably dried at 1000 ppm or less, more preferably 200 ppm or less by a vacuum dryer, a pressure reduced dryer or a dehumidified hot air dryer.

For example, the cellulose ester based resin dried by hot air, under vacuum or under reduced pressure is melted by the extruder 1 at an extrusion temperature of about 200 through 300° C. This material is then filtered by a leaf disk type filter 2 or the like to remove foreign substances.

The material is introduced from the supply hopper (not illustrated) to the extruder lunder a vacuum, a reduced pressure or an inert gas atmosphere to prevent decomposition by oxidation.

If additive agent such as a plasticizer is not added in advance, it can be added and kneaded during the extrusion process in the extruder A mixing apparatus such as a static mixer 3 is preferably used to ensure uniform addition.

In the present invention, amorphous thermoplastic resin and additive agent such as a stabilizer to be added as required are mixed preferably before melting. A mixer may be used for mixing. Alternatively, mixing may be done in the cellulose resin preparation process, as described above. When the mixer is used, it is possible to use a general mixer such as a V-type mixer, conical screw type mixer, and horizontal cylindrical type mixer.

As described above, cellulose resin containing additive agent can be once mixed, and it can be directly melted by the extruder 1 to form a film, however, pellets may be once made of cellulose resin containing additive agent, and then they can be melted by the extruder 1 to form a film. Further, when the cellulose resin containing additive agent contains a plurality of materials having different melting points, melting is performed at the temperature where only the material with the lowest melting point can be melted, thereby producing a half-molten material in which particles are dispersed in molten material. This half-molten material is put into the extruder 1 to form a film. When the cellulose resin containing additive agent contains a material that is easily thermal-decomposed, it is preferable to use the method of creating a film directly without producing pellets for the purpose of reducing the number of melting process, or the method of producing the half-molten material in which particles are dispersed in molten material, as described above, before forming a film.

Various types of extruders sold on the market can be used as the extruder 1, and a melting and kneading extruder is preferably used. Either the single-screw extruder or twin screw extruder may be utilized. If a film is produced directly from the cellulose resin containing additive agent without manufacturing the pellet, an adequate degree of kneading is required. Accordingly, use of the twin screw extruder is preferable. However, even the single-screw extruder can be used if the form of the single-screw is modified to be the kneading type screw such as a Maddox type, Unimelt type and Dulmage type, because this modification provides appropriate kneading. When the pellet and patchy half-molten material in which particles are dispersed in molten material is used as the cellulose resin, either the single-screw extruder and twin screw extruder can be used.

Inside the extruder 1 and in the process of cooling subsequent to extrusion, the density of oxygen is preferably reduced by replacement with such an inert gas as nitrogen gas, or by pressure reduction.

The desirable conditions for the melting temperature of the cellulose resin containing additive agent inside the extruder 1 differ depending on the viscosity of the cellulose resin containing additive agent and the discharge rate and the thickness of the sheet to be produced. Generally, the melting temperature is, where the glass transition temperature of the film is Tg or more without exceeding Tg+100° C., preferably Tg+10° C. or more without exceeding Tg+90° C. The melt viscosity at the time of extrusion is 10 through 100000 poises, preferably 100 through 10000 poises. Further, the shorter retention time of the cellulose resin in the extruder 1 is more preferably. This time is within 5 minutes, preferably within 3 minutes, more preferably within 2 minutes. The retention time depends on the type of the extruder 1 and conditions for extrusion, but can be reduced by adjusting the amount of the material supplied, and L/Dn screw speed, and depth of the screw groove.

The shape and speed of the screw of the extruder 1 are properly selected depending on the viscosity of the cellulose resin containing additive agent and the discharge rate. In the present invention, the shear rate of the extruder 1 is 1/sec through 10000/sec, preferably 5/sec through 1000/sec, more preferably 10/sec through 100/sec.

The extruder 1 in the present invention can be obtained as an ordinary plastic molding machine

The cellulose resin extruded from the extruder 1 is sent to the flow casting die 4 and is extruded from the slit of the flow casting die 4 in the form of a film.

The molten material extruded from the extruder is supplied to the flow casting die 4. There is no restriction to the flow casting die 4 if it can be used to manufacture a sheet and film. The material of the flow casting die 4 is exemplified by hard chromium, chromium carbide, chromium nitride, titanium carbide, titanium carbonitride, titanium nitride, cemented carbide and ceramics (e.g., tungsten carbide, aluminum oxide, chromium oxide), which are sprayed or plated, and are subjected to surface treatment by buffing, lapping with a grinding wheel having 1000 mesh or more, plane cutting with a diamond wheel having 1000 mesh or higher (cutting in the direction perpendicular to the resin flow), electrolytic polishing, and composite electrolytic polishing.

The lip of the flow casting die 4 is preferably made of the same material as that of the flow casting die 4. The surface accuracy of the lip is preferably 0.5S or higher, more preferably 0.2S or higher.

The present invention includes a step where a molten resin mixture is extruded in the form of a film from the flow-casting die 4 mounted on the extruder. In this step, the extruded film is molded by being brought in close contact with at least two cooling rolls (cooling drum), and is wound.

As shown in FIGS. 1 and 2, during the method of manufacturing an optical film of the present invention, when the glass transition temperature of the optical film is assumed as “Tg”, the temperature T1 of the film at the outlet of the flow-casting die 4 is within the temperature range expressed by Tg+60° C.−T1<Tg+130° C.; the temperature T2 of the film at point (P1) where the film comes in contact with the surface of the first roll 5 is within the temperature range defined by the relationship Tg<T2<Tg+120° C.; and the temperature T3 of the film at point (P2) where the film comes in contact with the surface of the second roll 6 is within the temperature range defined by the relationship Tg<T3<Tg+110° C., in addition, the flow-casting step from the lip opening of the flow-casting die to the point where the film flowing out of this lip opening comes in contact with the surface of the first roll can be processed under reduced pressure equal to or less than 70 kPa.

In this case, T1 indicates the temperature just when the film is extruded from the lip of the flow-casting die 4. This temperature can be measured by a commercially available contact or non-contact type thermometer.

In the present invention, the second roll 6 is a rotating member configured to press the film against the first roll 5 from the opposite side of the film with respect to the first roll 5. This is also called a touch roll. The surface of the second roll 6 is preferably made of metal with a thickness of 1 through 10 mm, more preferably 2 through 6 mm. The surface of the second roll 6 is preferably provided with chromium plating with a surface roughness of 0.2 S or less. The second roll 6 is preferably configured in a double sleeve structure where a space for the flow of cooling fluid inside the outer sleeve with aforementioned thickness is provided inside the outer sleeve and a metallic coaxial sleeve is provided further inside the space.

In the present invention, the second roll 6 preferably has a drum-like shape where the diameter of the roll at the center is greater than those on both ends The amount of crowning in this case is preferably in the range of 50 through 300 μm.

In the present invention, the diameter of the second roll 6 is preferably in the range of 200 through 500 mm.

In the present invention, the temperature of the film at the pressing section wherein the film is sandwiched and pressed between the first roll 5 and second roll 6 is preferably equal to or higher than the melting point of the additive agent, and the second roll 6 preferably presses the film under the pressure ranging from 0.1 N/mm through 100 N/mm. This arrangement prevents the surface of the roller of the first roll 5 from being contaminated with organic substances, and thereby keeping a smooth surface.

In the present invention, the melting point of the additive agent is defined, when only one type of additive agent is added, as the melting point of the additive agent, and defined as the melting point of the additive agent whose amount of addition has the greatest mass percentage when there more than one type of additive agent.

The temperature of the film at the pressing section can be calculated from the temperature of the film-like cellulose resin entering the pressing section and the temperature of the film formed at the pressing section both measured with a commercially available contact or non-contactless type thermometer to measure.

The temperature of the film at the pressing section can be set by adjusting the temperature of the film-like cellulose resin extruded from the flow-casting die 4 and the temperature on the surfaces of the first roll 5 and second roll 6

The width of the second roll 6 is required to be greater than the film-like cellulose resin to be pressed. When the neck-in of the film is so large that the thickness on both ends of the film is greater than the thickness at the center, the outer sleeve is preferably shaved off at the portions in contact with the thicker portions of the film. Further, the outer sleeve, at the ends of the second roll 6, is preferably shaved off to avoid contact with the first roll 5. The amount to be shaved of is in the range of 1 μm through 1 mm.

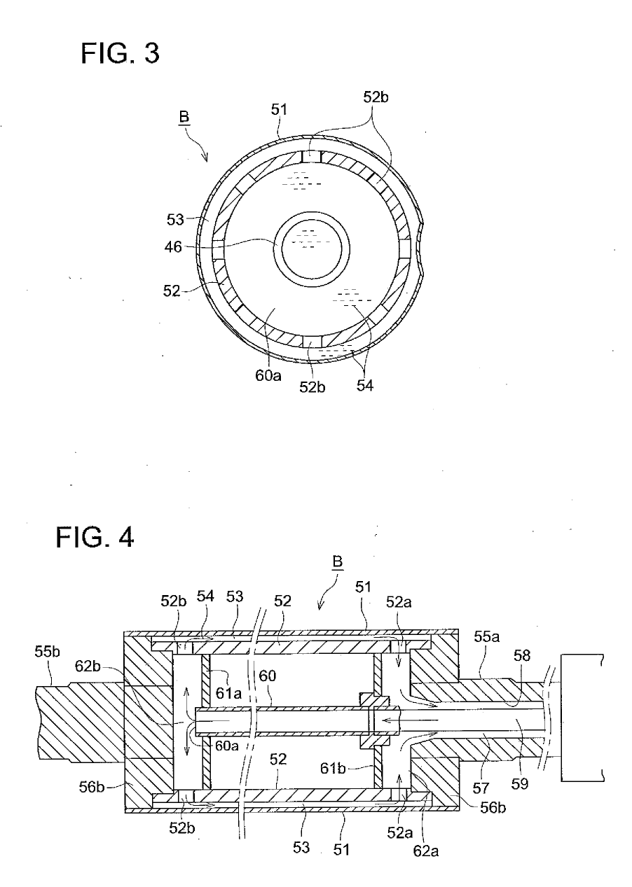

FIGS. 3 and 4 show a second touch roll B as an example. The second touch roll B is configured of an outer cylinder 51 made of a flexible and seamless stainless steel tube (thickness: 4 mm), and a highly rigid metallic inner cylinder 52 arranged centered on the same axial form inside the outer cylinder 51. Coolant 54 flows through the space 53 between the outer cylinder 51 and the inner cylinder 52. To put it in detail, the touch roll B is constructed in such a way that the rotary shafts 55a and 55b on both ends are provided with outer cylinder support flanges 56a and 56b, and a thin metallic outer cylinder 51 is mounted between the outer circumferential portions on both of the outer cylinder support flanges 56a and 56b. A fluid supply tube 59 is arranged coaxially in the fluid outlet 58 which is formed as a fluid return passage 57 at the axial portion of the rotary shaft 55a. This fluid supply tube 59 is fixedly connected to a fluid-shaft cylinder 60 arranged at the axial portion inside the thin metallic outer cylinder 51. The inner cylinder support flanges 61a and 61b are each mounted on both ends of the fluid-shaft cylinder 60. The metallic inner cylinder 52 with a thickness of about 15 through 20 mm is mounted from between the outer circumferences of the inner cylinder support flanges 61a and 61b to the outer cylinder support flange 56b on the other end. A coolant flow space 53 of about 10 mm is formed between the metallic inner cylinder 52 and the thin metallic outer cylinder 51. Outlets 52a and inlets 52b communicating between the flow space 53 and intermediate passages 62a and 62b outside the inner cylinder support flanges 61a and 61b are each formed in the vicinity of both ends of the metallic inner cylinder 52. The amount of crowning is set to 100 μm.

The present invention is effective when the average thickness of the film formed by being pressed between the first roll 5 and second roll 6 is in the range of 15 through 80 μm. If the average thickness of the film formed by being pressed between the first roll 5 and second roll 6 is in the range of 15 through 80 μm, the optical film having a thickness of 10 through 70 μm is produced by subsequent stretching and other processing.

In the present invention, the film-like cellulose ester based resin in the molten state coming from the T-die (flow-casting die) is brought in close contact with the first roll (first cooling roll) 5, second cooling roll 7, and third cooling roll 8 in that order. It is then conveyed and solidified by cooling whereby a pre-stretched film is produced.

In this case, the fourth roll 7a is preferably pressed against the second cooling roll 7, with the film sandwiched therebetween.

The fourth roll 7a is a rotating member intended to press the film against the second cooling roll 7 from the side opposite to the second cooling roll 7. The surface of the fourth roll 7a is preferably made of metal, and the thickness of this roll is in the range of 1 through 10 mm, preferably in the range of 2 through 6 mm. The surface of the fourth roll 7a is preferably processed with chromium plating and the like, and the surface roughness of this roll is preferably 0.2 S or less. The fourth roll 7a is preferably configured in a double sleeve structure where a space for the flow of cooling fluid and a metallic inner sleeve coaxial with the outer sleeve are located inside the outer sleeve having the aforementioned thickness.

In the present invention, the fourth roll 7a is preferably configured to have a drum-like shape where the outer diameter at the center is greater than those on both ends. The amount of crowning in this case is preferably in the range of 50 through 300 μm.

In the present invention, the diameter of the fourth roll 7a is preferably in the range of 200 through 500 mm.

In the present invention, the fourth roll 7a is preferably pressed against the film under the pressure of 0.1 through 100 N/mm. This arrangement prevents the roller surface of the second cooling roll 7 from being contaminated with organic substances, and ensures that its surface is kept smooth.

The width of the fourth roll 7a is required to be greater than that of the film to be pressed. When the amount of neck-in of the film is so large that the thickness at both ends of the film is greater than that at the center, the outer sleeve is preferably shaved off at the portions in contact with the thick portions of the film. Further, the ends of the second roll 6 are preferably shaved off for the purpose of avoiding contact with the first roll 5. The amount to be shaved off is in the range of 1 μm through 1 mm.

The same roll as the second roll 6 shown in FIGS. 3 and 4, for example, can be used as the fourth roll 7a.

In the present invention, when the flow-casting width exceeds 1500 mm, the advantages in the field of production are particularly noticeable.

When the film flow-casting width is 1500 mm or more, an optical film having a width of 2000 mm, after a stretching process and the like, can be obtained. The advantages of the present invention are particularly noticeable when the flow-casting width of the film is in the range of 1500 through 4000 mm, particularly in the range of 1700 through 4000 mm. The film having a flow-casting width of more than 4000 mm is not practical because stability may be reduced in the subsequent steps of conveyance and the like.

In the embodiment of the present invention shown in FIG. 1, the pre-stretched film 10 which is solidified by cooling and separated from the third cooling roll S by the separation roll 9, is led to the stretching machine 12 through the dancer roll (film tension adjusting roll) 11. The film 10 is stretched in the lateral direction (width direction) by the stretching machine. This stretching process orients the molecules in the film.

A known tenter can be preferably used in the method of stretching the film in the width direction. In particular, stretching the film in the width direction realizes the lamination with the polarizing film in the form of a roll. Stretching in the width direction ensures that the slow axis of the optical film is oriented in the width direction.

The transmission axis of the polarizing film is usually oriented in the width direction too. By incorporating into the liquid crystal display a polarizing plate which is laminated in such a way that the transmission axis of the polarizing film and the slow axis of the optical film are parallel to each other, a high contrast of the liquid crystal display and a good viewing angle are realized.

The film separated from the aforementioned cooling drum is preferably stretched longitudinally in one stage or multiple stages with one or more rolls and/or heating devices such as an infrared heater.

The film is preferably heated and stretched in the conveyance direction at the temperature of (Tg−30)° C. or more without exceeding (Tg+100)° C., or preferably (Tg−20)° C. or more without exceeding (Tg+80)° C., where the glass transition temperature is assumed as “Tg”.

After that the film stretched in the conveyance direction is preferably laterally stretched at the temperature of (Tg−20)° C. or more without exceeding (Tg+20)° C., and is then fixed by heating.

when laterally stretched, the film is preferably stretched, while the temperature is gradually raised, through more than one stretching region which have temperature difference of 1 through 50° C. between them, so that the distributions of the thickness in the width direction and optical characteristics are reduced.

The glass transition temperature Tg depends on the cellulose resin containing additive agent, and it can be controlled by changing the types of the materials constituting the film or their proportion. When a phase difference film is manufactured as the optical film, it is preferable that Tg is 120° C. or higher, preferably 135° C. or higher. In the liquid crystal display apparatus, the temperature environment of the film changes, while an image is displayed, due to the temperature rise of the apparatus itself, for example, due to the temperature rise caused by a light source. In this case, it Tg of the film is lower than the working environment temperature of the film, a big change occurs to the retardation value resulting from film geometry and the orientation of the molecules fixed by stretching conditions. If Tg of the film is too high, high temperature is required when the cellulose resin containing additive agent is formed into a film, and thus increasing the energy consumption for heating and decomposing the material to cooler the film at the time of forming a film. Therefore, Tg is preferably 250° C. or lower.

In the stretching process, known thermal fixing conditions, cooling process, or relaxation process can be executed, and appropriate adjustment may be made to obtain the characteristics required to the target optical film.

The aforementioned stretching process and thermal fixing process are selectively executed to provide the properties of the phase film and the functions of the phase film for the purpose of improving the viewing angle of the liquid crystal display apparatus. When such a stretching process and thermal fixing process are included, the thermal pressing process in the embodiment of the present invention should be performed prior to the stretching process and thermal fixing process.

When a phase difference film is produced as an optical film, and the functions of the polarizing plate protective film are combined to that, the refractive index is need to be controlled. The refractive index can be controlled in the stretching process and is a preferable way. The following describes the method for stretching:

In the stretching process of the phase difference film, required retardations Ro and Rth can be controlled by a stretching magnification of 1.0 through 2.0 times in one direction of the cellulose resin, and a stretching magnification of 1.01 through 2.5 times in the direction, in the film plane, perpendicular to that direction. Here Ro denotes an in-plane retardation, and it represents the thickness multiplied by the difference between the refractive index in the longitudinal direction MD and that in the width direction TD in the film plane, Rth denotes the retardation along the thickness, and represents the thickness multiplied by the difference between the refractive index (an average of the values in the longitudinal direction MD and in the width direction TD) in the film plane and that along the thickness.

Stretching can be performed sequentially or simultaneously, for example, in the longitudinal direction of the film and in the direction, in the film plane, perpendicular to that direction, namely, in the width direction. In this case, if the stretching magnification at least in one direction is insufficient, sufficient phase difference cannot be obtained. If the stretching magnification is excessive, stretching gets difficult, and the film may break.

Stretching in the biaxial directions perpendicular to each other is an effective way for keeping the film refractive indexes nx, ny and nz within a predetermined range. Here ax denotes a refractive index in the longitudinal direction MD, ny denotes that in the width direction TB, and nz denotes that along the thickness.

When the material is drawn in the melt-casting direction and it causes excessive shrinkage in the width direction, the nz value will be excessive. This can be improved by controlling the shrinkage of the film in the width direction or by stretching in the width direction. In the case of stretching in the width direction, distribution may occur to the refractive index in the width direction. This distribution may appear when a tenter method is utilized. Stretching of the film in the width direction causes shrinkage force to appear at the center of the film because the ends are fixed in position. This is considered to be what is called “bowing phenomenon”. In this case, the bowing phenomenon can be controlled by stretching in the casting direction, and the distribution of the phase difference in the width direction can be reduced.

Stretching in the biaxial directions perpendicular to each other reduces the fluctuation in the thickness of the obtained film. Excessive fluctuation in the thickness of the phase difference film will cause irregularity in phase difference. When used for liquid crystal display apparatus, irregularity in coloring or the like may occur.

The fluctuation in the thickness of the cellulose resin film is preferably kept within the range of ±3%, further down to ±1%. To achieve the aforementioned object, it is effective to use the method of stretching in the biaxial directions perpendicular to each other. In order to get a required retardation value, the magnifications of stretching in the biaxial directions perpendicular to each other are each, at the end of the process, preferably 1.0 through 2.0 in the casting direction, and 1.01 through 2.5 in the width direction. Stretching in the range of 1.01 through 1.5 in the casting direction and in the range of 1.05 through 2.0 in the width direction are more preferable.

When the absorption axis of the polarizer is present in the longitudinal direction, the transmission axis of the polarizer lies in the width direction. To get a lengthy polarizing plate, the phase difference film is preferably stretched so as to get a slow axis in the width direction.

When using the cellulose resin with positive birefringence with respect to stress, stretching in the width direction provides the slow axis of the phase difference film in the width direction due to the aforementioned arrangement, In this case, to improve display quality, the slow axis of the phase difference film preferably lies in the width direction. To get the target retardation value, it is necessary to meet the following relationship:

(Stretching magnification in the width direction)>(stretching magnification in the casting direction)

After stretching, the ends of the film re shaved off by a slitter 13 to the width for the products. Then both ends of the film are knurled (embossed) by a knurling apparatus made up of an emboss ring 14 and back roll 15, and the film is wound by a winder 16. This arrangement prevents sticking in the optical film F (raw fabric roll) or scratch. Knurling can be provided by thermal pressing with a metallic ring having a pattern of projections and depressions on the lateral surface. The gripping portions of the clips on both ends of the film are normally deformed and cannot be used as film products. They are therefore cut out and are recycled as raw materials.

When the phase difference film is used as a protective film in the polarizing plate, the thickness of the aforementioned protective film is preferably 10 through 500 μm. In particular, the lower limit is 20 μm or more, preferably 35 μm or more. The upper limit is 150 μm or less, preferably 120 μm or less. A still more particularly preferred range is 25 through 90 μm. If the phase difference film is too thick, the fabricated polarizing plate will be too thick. This fails to meet the requirement for low-profile and light weight for the liquid crystal display for notebook PCs and mobile type electronic devices 8. To the contrary, if the phase difference film is too thin, retardation as a phase difference film cannot appear easily. Further, the film moisture permeability will be increased, with the result that the polarizer cannot be effectively protected from moisture. This is not preferable.

The slow axis or fast axis of the phase difference film is present in the same plane of the film. Where the angle between the axis and the direction of film formation is θ1, the θ1 should be −1 degrees or more without exceeding +1 degrees, preferably −0.5 degrees or more without exceeding +0.5 degrees.

This θ1 can be defined as an orientation angle, and it can be measured by an automatic birefringence meter KOBRA −21ADH (by Oji Scientific Instruments).

It θ1 meets the aforementioned relationship, a high degree of brightness is ensured in the display image and a leakage of light is reduced or prevented, with the result that faithful color reproduction is provided in the color liquid crystal display apparatus.

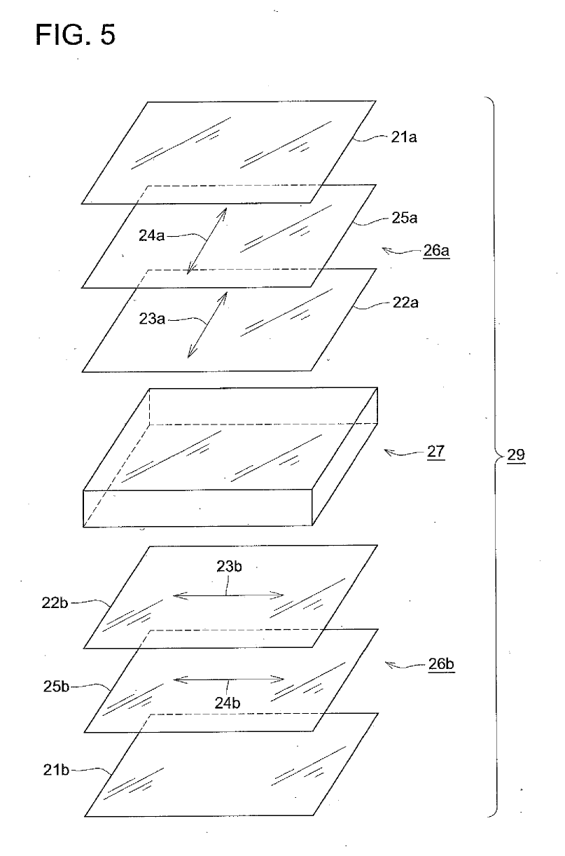

In the case that the phase difference film of an embodiment of the present invention is used in the multiple-domain VA mode, if the phase difference film is arranged such that the fast axis of the phase difference film is within the range of θ1 described above, it helps the display quality of the image to be improved. The polarizing plate and liquid crystal display apparatus with MVA mode can be configured as shown in FIG. 5, for example.

In FIG. 5, the reference numerals 21a and 21b indicate protective films, 22a and 22b represent phase difference films, 25a and 25b show polarizers, 23a and 23b indicate the slow axis directions of the film, 24a and 24b show the transmission axis direction of the polarizer, 26a and 26b denote polarizing plates, 27 shows a liquid crystal cell, and 29 denotes a liquid crystal display apparatus.

The distribution of the retardation Ro in the in-plane direction of the optical film is adjusted to preferably 5% or less, more preferably 2% or less, still more preferably 1.5% or less. Furthers the distribution of retardation Rt along the thickness of the film is adjusted to preferably 10% or less, more preferably 2% or less, still more preferably 1.5% or less.

The numerical value for the retardation distribution is defined by the fluctuation coefficient (CV) of the retardation obtained by measuring the retardation of the obtained film in the width direction at intervals of 1 cm. Regarding other method to measure the retardation and the numerical value for its distribution, the standard deviations of the in-plane retardation and retardation along the thickness are calculated by the (n−1) method, and the fluctuation coefficient (CV) shown below is thus obtained to be an indicator. For measurements, calculation can be made by setting “In” at 130 through 140.

Fluctuation coefficient (CV)=standard deviation/average retardation value

In the phase difference film, the distribution fluctuation in the retardation value is preferably smaller when the polarizing plate including the phase difference film is used in the liquid crystal display apparatus, the fluctuation in retardation distribution is preferably smaller from the viewpoint of minimizing color irregularities.

The phase difference film is allowed to have a wavelength dispersion of the retardation value. When this film is used in the liquid crystal display element similar to the aforementioned case, the wavelength dispersion can be properly selected in order to improve the display performance. Here, similar to the measurement value Ro of the phase difference film at 590, the in-plane retardation at 450 nm is defined as R450 and the in-plane retardation at 650 nm is defined as R650.

When the MVA (to be described later) is used in the display apparatus, the wavelength dispersion in the in-plane retardation of the phase difference film is preferably 0.7<(R450/Ro)<1.0 and 1.0<(R650/Ro)<1.5, more preferably 0.7<(R450/Ro)<0.95 and 1.01<(R650/Ro)<1.2, still more preferably 0.8<(R450/Ro)<0.93 and 1.02<(R650/Ro)<1.1. This arrangement ensures display with excellent color reproduction.

In order to adjust the phase difference film so as to provide the retardation value suitable for improvement of the display quality of the liquid crystal cell in the VA mode or TN mode and especially suitable for the aforementioned multidomained VA mode for preferable use as the MVA mode, the in-plane retardation Ro is required to be greater than 30 nm without exceeding 95 nm, and retardation Rt along the thickness to be greater than 70 nm without exceeding 400 nm.

The aforementioned retardation (Ro) compensates mostly the leakage of light due to the deviation from cross-nicols caused by observing from the direction oblique to the normal line of the display surface when the two polarizing plates are arranged under crossed-nicols, the liquid crystal cell is arranged between the polarizing plates, as shown in FIG. 5, and the polarizing plates are under cross-nicols being viewed from the normal line of the display surface. In the aforementioned TN mode and VA mode, particularly in the MVA mode, when the liquid crystal cell is in the black-and-white display state, the retardation in the thickness direction contributes to also compensate the birefringence of the liquid crystal cell observed when viewed from the oblique direction.

As shown in FIG. 5, in the case that two polarizing plates are provided on and beneath the liquid crystal cell in the liquid crystal display apparatus, the retardation (Rth) along the thickness can be selectively divided into two portions each on the reference numerals 22a and 22b in FIG. 5, it is preferable that each of the portion satisfies the above mentioned range and the total of the two portions is greater than 140 nm without exceeding 500 nm. In this case, both the in-plane retardation (Ro) and the retardation Rt in the thickness direction of the 22a and 22b are the same for improving the productivity of industrial production of polarizing plates. It is particularly preferable that the phase difference films are applied to the liquid crystal cell in the MVA mode shown in FIG. 3 with the in-plane retardation (Ro) being greater than 35 nm without exceeding 65 nm, the retardation (Rth) in the thickness direction being greater than 90 nm without exceeding 180 nm.

In the liquid crystal display apparatus, if the TAC film having an in-plane retardation (Ro) of 0 through 4 nm, a retardation (Rth) in the thickness direction of 20 through 50 nm and a thickness of 35 through 85 μm is used, for example, as a commercial protective film for a polarizing plate at the position of 22b in FIG. 3 in one of the polarizing plates, the polarizing film arranged on the other polarizing plate, for example, the polarizing film arranged in 22a of FIG. 3 is preferred to have an in-plane retardation (Ro) of greater than 30 nm without exceeding 95 nm, and the retardation (Rth) in the thickness direction of greater than 140 nm without exceeding 400 nm. This arrangement improves the display quality and is preferably in terms of film productivity.

<Liquid Crystal Display Apparatus>

The polarizing plate (referred to as a polarizing plate of the present invention) including the phase difference film of the present invention provides higher display quality than the normal polarizing plate. This is particularly suited for use in a multi-domain type liquid crystal display, more preferably to the multi-domain type liquid crystal display in the birefringence mode.

Use of the multiple domain is effective in improving the symmetry property of an image display, and various methods therefore have been reported “Okita, Yamauchi: Liquid Crystal, 6(3), 303 (2002)”. That liquid crystal display cell is also described in “Yamada, Yamahara: Liquid Crystal, 7(2), 184 (2003)”, without the present invention being restricted thereto.

The polarizing plate of the present invention can be effectively utilized in the MVA (Multi-domain Vertical Alignment) mode represented by vertical alignment, particularly in the MVA mode split into four regions, conventionally known PVA (Patterned Vertical Alignment) mode with the multiple domain formed by arrangement of electrodes, and CPA (Continuous Pinwheel Alignment) mode based on a combination of alignment of electrodes and chiral power. Further, for adaptation to the OCB (Optical Compensated Bend) mode, an optically biaxial film has been disclosed “T. Miyashita, T. Uchida: J.SID, 3(1), 29 (1995)”, and the display performance can be realized by the polarizing plate of the present invention. There is no particular restriction to the liquid crystal mode or arrangement of the polarizing plate, as long as the display performance can be realized by the use of the polarizing plate of the present invention.

Regarding the display performance of a display cell, bilateral symmetry is preferable at the time of human observation. Accordingly, when a liquid crystal display cell is used as the display cell, the domain may be multi domained to put a priority on the symmetry on the observation side. A conventionally known technique can be used to divide the domain. A proper method such as a two-part split method, preferably four-part split method, can be used with consideration given to the properties of the conventionally known liquid crystal modes.

The liquid crystal display is getting colorized and is put into practical use as an apparatus for displaying motion pictures. The display quality is improved by the embodiment of the present invention. The improved contrast and enhanced polarizing plate durability realizes a faithful and less fatiguing motion picture display.

In the liquid crystal display containing at least the polarizing plate incorporating a phase difference film of the present invention, one polarizing plate containing the phase difference film of the present invention is arranged on the liquid crystal cell, or two of those polarizing plates are arranged on both sides of the liquid crystal dell. In these cases, the display quality is improved when the phase difference film, of the present invention, contained in the polarizing plate is made to face directly the liquid crystal cell of the liquid crystal display. The films 22a and 22b of FIG. 5 are made to face the liquid crystal cell of the liquid crystal display

In the aforementioned structure, the phase difference film of the present invention provides optical compensation for the liquid crystal cell. When the polarizing plate of the present invention is used in the liquid crystal display apparatus, at least one of the polarizing plates of the liquid crystal display apparatus has to be a polarizing plate of the present invention. Use of the polarizing plate of the present invention improves the display quality, and thereby providing a liquid crystal display apparatus having excellent viewing angle

In the polarizing plate of the present invention, a polarizing plate protective film of cellulose derivative is used on the surface, of the polarizer, opposite to the phase difference film. As the protective film, general-purpose TAC film or the like can be employed. The polarizing plate protective film, which is located far from the liquid crystal cell, can be provided with another functional layer for the purpose of improving the quality of the display apparatus.

It can be disposed on the surface of the polarizing plate of the present invention or on a film containing, as a constituent object, a known functional layer, for display devices, which is well known and is aiming for avoiding reflection, glare, scratch or dust, and for improving brightness,

without being restricted thereto.

Generally, to ensure stable optical characteristics, the aforementioned retardation value Ro or Rth of the phase difference film is required to be small. In particular, these fluctuations may cause irregularities of an image in the liquid crystal display in the birefringence mode.

For a lengthy phase difference film manufactured by the solution-casting film forming method, the retardation value may vary according to the volatilization of a trace quantity of the organic solvent remaining in the film. The lengthy phase difference film is manufactured, stored, and transported in the form of a length roll, and is manufactured into the polarizing plate by polarizing plate manufacturers. Therefore, a greater amount of the solvent remains in the deeper position in the roll, and the volatility is more reduced there. Therefore, there is a slight difference in the density of a trace quantity of the remaining solvent, over the range from the outer part of the roll to the inner part, and from both edges to the center in the width direction. This has triggered occurrence of a chronological change and fluctuation of the retardation value in some cases in the conventional art.

In the present invention, the lengthy phase difference film is manufactured by the melt-casting film forming method. Unlike the solution-casting film forming method, there is no solvent to be volatilized. This invention provides a roll film characterized by the minimized chronological change and fluctuation in the retardation value. The present invention has advantages in that a lengthy phase difference film is manufactured by continuously stretching the film manufactured by the melt-casting film forming method.

A longer phase difference film produced by the melt-casting film forming method according to the present invention is mainly made of a cellulose resin. Therefore, it possible to use the process of alkaline treatment based on saponification inherent to the cellulose resin. Therefore, when the resin constituting the polarizer is polyvinyl alcohol, the polarizer can be bonded with the phase difference film of the present invention using aqueous solution containing a completely saponified polyvinyl alcohol similarly to the case of the conventional. Thus, the present invention is superior in that the method for manufacturing the conventional polarizing plate can be applied. It is especially advantageous in that a lengthy roll polarizing plate can be obtained.

When manufacturing the phase difference film according to the present invention, a functional layer such as antistatic layer, hard coated layer, easy glidability layer, adhesive layer, antiglare layer or barrier layer can be coated before and/or after stretching. In this case, various forms of surface treatment such as corona discharging, plasma processing, and chemical solution treatment can be provided as appropriate.

In the film making process, the gripping portions of the clips on both ends of the film having been cut can be recycled as the material of the same type or different type of films, after having been pulverized, or after having been applied as required.

An optical film of lamination structure can be produced by co-extrusion of the compositions containing cellulose resins having different concentrations of additives such as the aforementioned plasticizer, ultraviolet absorber and matting agent. For example, an optical film made up of a skin layer/core layer/skin layer can be produced. For example, a large quantity of matting agent can be put into the skin layer, or the matting agent can be put only into the skin layer. Plasticizer and ultraviolet absorber can be put into the core layer in a larger amount than into the skin layer. They can be put only in the core layer. Further, different types of the plasticizer and ultraviolet absorber can be added in the core layer and skin layer. For example, it is also possible to make such arrangements that the skin layer contains a plasticizer and/or ultraviolet absorber of lower volatility, and that the core layer contains a plasticizer of excellent plasticity or an ultraviolet absorber of excellent ultraviolet absorbing performance. The glass transition temperatures between the skin layer and core layer can be different from each other. The glass transition temperature of the core layer is preferably lower than that of the skin layer. In this case, the glass transition temperatures of both the skin and core are measured, and the average value obtained by calculation with their volume fraction added is defined as the aforementioned glass transition temperature Tg so that it is handled in the same manner. Further, the viscosity of the molten material including the cellulose ester at the time of melt-casting can be different in the skin layer and core layer. The viscosity of the skin layer can be greater than that of the core layer. Alternatively, the viscosity of the core layer can be equal to or greater than that of the skin layer.

Assuming that the dimension of the film which has been left for 24 hours at a temperature of 23° C. with a relative humidity of 55% RH is the standard, the dimensional stability of the optical film of the present invention is such that the fluctuation of the dimension at 80° C. and 90% RH is less than ±2.01, preferably less than ±1.01, more preferably less than ±0.5%.

In the case that the optical film of the present invention is used as a protective film in the polarizing plate as the phase difference film, if the phase difference film has a fluctuation exceeding the aforementioned range, the absolute value of the retardation and the orientation angle as a polarizing plate will deviate from the initial setting. This may cause reduction in the capability of improving the display quality, or may result in deterioration of the display quality.

The phase difference film of the present invention can be used as the polarizing plate protective film. When used as a polarizing plate protective film, there is no restriction to the method of producing the polarizing plate. The polarizing plate can be manufactured by a commonly used method. The phase difference film having been obtained is subjected to alkaline treatment. Using an aqueous solution of completely saponified polyvinyl alcohol, the polarizing plate protective films can be bonded on the both surfaces of the polarizer manufactured by immersing the polyvinyl alcohol film in an iodonium solution and by stretching the same. When this method is used, the phase difference film as the polarizing plate protective film in the embodiment of the present invention is directly bonded to at least one of the surfaces of the polarizer.

Instead of the aforementioned alkaline treatment, the film can be provided with simplified adhesion as disclosed in Japanese Laid-Open Patent Publication No. H06-94915 and Japanese Laid-Open Patent Publication No. H06-118232.

The polarizing plate is made up of a polarizer and protective films for covering both surfaces thereof. Further, a film for protection can be bonded onto one of the surfaces of the aforementioned polarizing plate and a release sheet can be bonded on the other surface. The film for protection and the release sheet are used to protect the polarizing plate at the time of product inspection and shipment of the polarizing plate. In this case, the film for protection is bonded to protect the surface of the polarizing plate, and is used on the surface opposite to the surface at which the polarizing plate is to be bonded to the liquid crystal. Further, the release sheet is used to cover the adhesive layer to be bonded to the liquid crystal panel, and is used on the surface at which the polarizing plate is bonded to the liquid crystal cell.

### WORKING EXAMPLES

The present invention is specifically described as follows with reference to the working examples, without restricted thereto.

### Working Example 1

### Preparation of Sample 101

Cellulose acetate propionate . . . 100 parts by mass (Replacement ratio of acetyl group; 1.4; replacement ratio of propionyl group: 1.35; average number particle size: 60,000; where the replacement ratio of the acyl group such as an acetyl group, propionyl group and butyryl group, was measured according to the stipulations of ASTM-D817-96.)

Additive Agent

Trimethyl propane tribenzoate (plasticizer, melting point: 85° C.) . . . 10 parts by mass

(Irganox XP 420/FD stabilizer by Chiba Specialty Chemicals K.K) . . . 1 part by mass

Ultraviolet absorber Ti928 (by Chiba Specialty Chemicals K.K) . . . 1.5 parts by mass

Matting agent (Seahoster-KEP-30 by Japan Catalyst, Silica particulate having an average particle size of 0.3 μmm) . . . 0.1 parts by mass

The aforementioned materials were mixed by a V-shaped mixer for 30 minutes and were dissolved in an atmosphere of nitrogen at 230° C. using a twin-screw extruder provided with a strand die, whereby cylindrical pellets having a length of 4 mm and a diameter of 3 mm were produced. The pellets having been produced were dried at 100° C. for five hours until the moisture content reached a level of 100 ppm. The pellets were supplied to a single-screw extruder equipped with a T-die, whereby a film was produced. The speed of the screw of the single-screw extruder was adjusted in such a way that the screw diameter would be 90 mm, the L/D would be 30 and the amount of extrusion would be 140 kg/h. Nitrogen gas was charged from the position close to the material inlet to maintain a nitrogen atmosphere in the extruder. The extruder and T-die were set to the temperature of 240° C. The T-die was a coat hanger die and had a width of 2400 mm. The inner wall was plated with hard chromium, and the die was mirror-finished to a surface roughness of 0.01 S. The lip gap of the T-die was set to 1 mm.

The film coming out of the T-die (a temperature of 240° C.: T1) was dropped onto a first rotating member having a chromium plated mirror-finished surface with a roll width of 3000 mm wherein the surface temperature was adjusted to 100° C. At the same time, the film was pressed by a second rotating member with a roll width of 2400 mm wherein the surface temperature was adjusted to 100° C. The film temperature in this point of process was 180° C. (T2), which was higher than the temperature of 100° C. which was equal to or greater than the melting point of the plasticizer which had the greatest percentage of addition in terms of mass ratio out of the additives such as plasticizer, stabilizer, and ultraviolet absorber. The film, which had a width of 2400 mm when extruded from the T die, was made to have a width of 2200 mm by neck-in when it touched to the first rotating member. In addition, the second rotating member was pressed against the first rotating member at a linear pressure of 4 N/mm.

The film sandwiched between the first and second rotating members was then conveyed to a third rotating member. Then, the film was pressed by a fourth rotating member against the third rotating member at a linear pressure of 10 N/mm, where the temperature of the fourth rotating member was adjusted to 90° C. After that, the film was conveyed by a conveyance roller and the film edge was slit by a slitter. The resulting film with a width of 2000 mm was wound up by a winder.

(Preparation of Samples 102 through 114)

Films of the samples 102 through 114 were produced by changing the distance between the film which is flow-cast from the T-die and the first rotating member, the pressing force of the second rotating member, and the pressing force of the fourth rotating member. In the Table, the samples which have no description of pressing or pressing force are the samples prepared without that rotating member.

(Measurement of Flow-Cast Film Temperature)

The temperature of the film surface was measured by a contact type handy thermometer (Anritsu Digital Thermometer HA-100K). To put it more specifically, the temperatures were measured at five points in the width direction of the film being conveyed. The highest temperature was assumed as the film temperature.

(Evaluation Method)

While each sample was flow-cast for three hours, contamination of the first and third rotating members and contamination of the film were visually inspected, and they were rated on a scale of 1 to 5.

5: No contamination was observed after three-hour flow-casting.

4: Slight contamination was observed after three-hour flow-casting.

3: Slight contamination was observed after one-hour flow-casting.

2: Contamination was observed after ten-minute flow-casting, and became heavier with time.

1: Contamination was observed right after the start of flow-casting, and became worse with time.

Further, contamination of the film was visually inspected, and was rated on a scale of 1 to 3.

3: No contamination was observed after three-hour flow-casting.

2: Slight contamination was partially observed after three-hour flow-casting.

1: Contamination was observed after ten-minute flow-casting, and became worth with time.

The results are given in Table 1.

TABLE 1

| | | | | Contamination | Contamination | | |
|---|---|---|---|---|---|---|---|
| | | | | on | on | | |
| | | | | first | third | | |
| Sample | A | B | C | rotating | rotating | Contamination | |
| No. | (° C.) | (N/mm) | (N/mm) | member | member | on film | Remarks |
| 101 | 180 | 4 | 10 | 5 | 5 | 3 | Inv. |
| 102 | — | — | — | 1 | 2 | 1 | Comp. |
| 103 | 70 | 4 | — | 2 | 2 | 1 | Comp. |
| 104 | 90 | 4 | — | 4 | 3 | 2 | Inv. |
| 105 | 130 | 4 | — | 5 | 3 | 3 | Inv. |
| 106 | 180 | 0.05 | — | 2 | 2 | 1 | Comp. |
| 107 | 180 | 0.1 | — | 5 | 3 | 3 | Inv. |
| 108 | 180 | 10 | — | 5 | 3 | 3 | Inv. |
| 109 | 180 | 100 | — | 4 | 3 | 3 | Inv. |
| 110 | 180 | 150 | — | 2 | 2 | 1 | Comp. |
| 111 | 180 | 4 | 0.05 | 5 | 3 | 3 | Inv. |
| 112 | 180 | 4 | 0.1 | 5 | 5 | 3 | Inv. |
| 113 | 180 | 4 | 100 | 5 | 5 | 3 | Inv. |
| 114 | 180 | 4 | 150 | 5 | 4 | 3 | Inv. |

Hydrophilic polymer
A: Film temperature at the time of being pressed
B: Linear pressure of the second rotating member
C: Linear pressure of the fourth rotating member
Inv.: Present invention,
Comp.: Comparative example

Table 1 shows that the present invention has made a substantial contribution to the reduction of contamination on the first and third rotating members and the film.

1. A method for manufacturing an optical film, the method comprising, in the following order, the steps of:
melting a cellulose resin into a molten cellulose resin, the cellulose resin including additive agent;
extruding the molten cellulose resin from a melt-casting die in a film-like form by using an extruder; and
forming a film by pinching the extruded film-like cellulose resin between a first rotating member and a second rotating member,
wherein temperature of the film-like cellulose resin pinched between the first rotating member and the second rotating member is equal to or higher than a melting point of the additive agent, and a line pressure between the first rotating member and the second rotating member when the film-like cellulose resin is pinched is from 0.1 to 100 N/mm.

2. The method of manufacturing an optical film of claim if comprising, after the step of forming the film by pinching between the first rotating member and the second rotating member, the step of:
conveying the film by a third rotating member.

3. The method of manufacturing an optical film of claim 2, comprising the step of:
stretching the film conveyed by the third rotating member.

4. The method of manufacturing an optical film of claim 2, wherein a forth rotating member is pressed against the third rotating member with the film pinched therebetween.

5. The method of manufacturing an optical film of claim 4, wherein a pressing pressure of the forth rotating member is from 0.1 to 100 N/mm.

6. The method of manufacturing an optical film of claim 1, comprising, before the step of extruding, the step of:
drying to reduce volatile component in at least either of the additive agent and the cellulose resin.

7. The method of manufacturing an optical film of claim 6, wherein in the step of drying, a material to be dried is heated to a temperature equal to or less than a glass transition point of the material to be dried.

8. The method of manufacturing an optical film of claim 1, wherein a width of the cellulose resin extruded from the melt-casting die is from 1500 to 4000 mm.

9. The method of manufacturing an optical film of claim 1, wherein average thickness of the film is made to be from 15 μm to 80 μm in the step of forming the film by pinching between the first rotating member and the second rotating member is.

10. An optical film manufactured by a method which comprises, in the following order, the steps of:
melting a cellulose resin into a molten cellulose resin, the cellulose resin including additive agent;
extruding the molten cellulose resin from a melt-casting die in a film-like form by using an extruder; and
forming a film by pinching the extruded film-like cellulose resin between a first rotating member and a second rotating member,
wherein temperature of the film-like cellulose resin pinched between the first rotating member and the second rotating member is equal to or higher than a melting point of the additive agent, and a line pressure between the first rotating member and the second rotating member when the film-like cellulose resin is pinched is from 0.1 to 100 N/mm.
